(19) United States
(12) Patent Application Publication
(10) Pub. No.: US 2012/0143834 A1
(43) Pub. Date: Jun. 7, 2012

(54) DATA SUMMARY SYSTEM, METHOD FOR SUMMARIZING DATA, AND RECORDING MEDIUM

(75) Inventors: Tomoo Ebiyama, Tokyo (JP); Kouji Kida, Tokyo (JP); Kenichiro Fujiyama, Tokyo (JP)

(73) Assignee: NEC CORPORATION, Minato-ku, Tokyo (JP)

(21) Appl. No.: 13/390,021

(22) PCT Filed: Jul. 27, 2010
(86) PCT No.: PCT/JP2010/062613

§ 371 Date: Feb. 10, 2012

(30) Foreign Application Priority Data
Aug. 12, 2009 (JP) 2009-187587

(51) Int. Cl. G06F 7/00

(52) U.S. Cl. 707/693; 707/E17.002

(57) ABSTRACT

Each time sequential data is generated by a data generation source (001), the data is inputted into a sequential data memory unit (002) and accumulated in a memory device. Each time sequential data is inputted, a sequence summary unit (003) creates a sequence approximation function that approximates the inputted sequential data and previously inputted sequential data. A summary result memory unit (008) stores the sequence approximation functions that were created by the sequence summary unit (003). At specified timing, an accumulated data summary unit (005) creates, from a specified range of sequential data that was accumulated in the sequential data memory unit (002), a collective approximation function that approximates that sequential data with that range as the domain. A summary result evaluation unit (007) replaces the sequence approximation functions that were stored in the summary result memory unit (008) with the collective approximation function that has a domain that includes the range of the domains of the sequence approximation functions.

### TECHNICAL FIELD

The present invention relates to a data summary system, a method for summarizing data and a recording medium that reduces the amount of information by summarizing sequentially generated data.

### BACKGROUND ART

As related art for reducing the amount of information by summarizing sequentially generated data, there is, for example, Patent Literature 1 that discloses a data collection device that dynamically compresses input data. The data collection device disclosed in Patent Literature 1 comprises: an input processing unit that reads data from an input source such as an external device, and stores the data in a input data array memory unit; a compression processing unit that reads input data array memory unit in which the input processing unit stores data, and performs compression processing; a saving unit that saves the compressed data that was compressed by the compression processing unit in a storage device that is a memory device; and a setting unit that sets the operation and function of the input processing unit and compression processing unit. The input processing unit collects and stores data according to whether the data is bit data or numerical data, and the compression processing unit performs compression processing. The compression process divides input information into bit data and numerical data, and according to the characteristics of the time-series of each kind of data, estimates input values, finds the difference between the estimated values and real input values, and reduces the amount of data by expressing difference values that appear frequently with a short code.

Patent Literature 2 discloses a method for compressing time-series data that is able to dynamically and easily set the compression rate for time-series data according to an event such as an alarm or operation related to the time-series data, without relying on an initial setting.

The time-series data compression method disclosed in Patent Literature 2, calculates reference values that correspond to the type of event related to each respective time-series data in order to determine whether or not to delete the data, and compresses the time-series data by setting which data of the time-series data to delete according to a judgment criteria that is preset based on the reference values that are calculated for each data.

Patent Literature 3 discloses a data communication system in a monitoring device that receives the whole trend of a data array even when the amount of transferred data is large and the communication capacity is small. The data communication system disclosed in Patent Literature 3 provides a data selection unit between a data storage unit and data transmission unit, and gives priority to transmitting data necessary for understanding the trend of the overall data, and furthermore, provides a data receiving device with a function in a data receiving device for rebuilding the data.

Patent Literature 4 discloses technology of a data compression and storage device that includes a time-series signal. The data compression and storage device disclosed in Patent Literature 4 comprises: a temporary storage unit that temporarily stores plant data; a data partitioning unit that partitions a specified amount of the data stored in the temporary storage unit; a data approximation unit that finds an approximation expression that expresses the displacement of data as a function of time within the range of the data partitioned by the data partitioning unit; a deviation calculation unit that finds the deviation between the approximation found by the data approximation unit and the actual plant data; a save judgment processing unit that compares the deviation found by the deviation calculation unit with a preset threshold value, and performs a save request when the deviation exceeds the threshold value, then updates the data partitioning according to this judgment; and a data saving unit that saves data according to the save request from the save judgment processing unit.

### PRIOR ART LITERATURE

### Patent Literatures

Patent Literature 1: Unexamined Japanese Patent Application Kokai Publication No. 2006-259937
Patent Literature 2: Unexamined Japanese Patent Application Kokai Publication No. 2003-015734
Patent Literature 3: Unexamined Japanese Patent Application Kokai Publication No. H08-275262
Patent Literature 4: Unexamined Japanese Patent Application Kokai Publication No. H04-299478

### SUMMARY OF INVENTION

### Problems to be Solved by the Invention

In the related art disclosed in Patent Literature 1, in order to perform real-time analysis with no time lag, data is sequentially summarized each time sequentially generated data is acquired instead of waiting for all of the data to be collected before summarizing, so that there is a limit to the summary precision and summary rate.

The related art of Patent Literature 2 to Patent Literature 4 are each a method of compressing a specified range of data after accumulating a specified amount of data. Therefore, these methods are not suitable for performing real-time analysis with no time lag.

Therefore, the object of the present invention is to provide a data summary system, a method of summarizing data and a recording medium capable of sequentially summarizing data that is sequentially generated, reducing time lag before analysis begins, as well as achieving high summary precision and a high precision rate.

### Means for Solving the Problem

A data summary system according to a first aspect of the present invention comprises:

an input unit that inputs sequential data, which is data that is sequentially generated and comprises information that includes the order of generation and the value at that time, and accumulates that sequential data in a memory device every time the sequential data is generated;

a sequence summary unit that, every time the sequential data is inputted, creates one of:

a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;

a sequence approximation function in which the sequence domain of the sequence approximation function that was created when the previous one inputted sequential data is extended up to the newly inputted sequential data, and the specified function parameter that was created when the previous one inputted sequential data is changed so as to approximate the values of the sequential data included in the extended sequence domain; or

a sequence approximation function in which the sequence domain of the sequence approximation function that was created when the previous one inputted sequential data is extended up to the newly inputted sequential data, and the specified function parameter that was created when the previous one inputted sequential data is maintained;

a summary memory unit that stores the sequence approximation function that was created by the sequence summary unit;

an accumulated data summary unit that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and

a summary result evaluation unit that replaces the sequence approximation functions that are stored in the summary memory unit with the collective approximation function that has the collective domain that includes the range of sequence domains of the sequence approximation functions.

A data summary method according to a second aspect of the present invention comprises:

an input step that inputs sequential data, which is data that is sequentially generated and comprises information that includes the order of generation and the value at that time, and accumulates that sequential data in a memory device every time the sequential data is generated;

a sequence summary step that, every time the sequential data is inputted, creates one of:

a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;

a sequence approximation function in which the sequence domain of the sequence approximation function that was created when the previous one inputted sequential data is extended up to the newly inputted sequential data, and the specified function parameter that was created when the previous one inputted sequential data is changed so as to approximate the values of the sequential data included in the extended sequence domain; or

a sequence approximation function in which the sequence domain of the sequence approximation function that was created when the previous one inputted sequential data is extended up to the newly inputted sequential data, and the specified function parameter that was created when the previous one inputted sequential data is maintained;

a summary memory step that stores the sequence approximation function that was created by the sequence summary step;

an accumulated data summary step that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and

a summary result evaluation step that replaces the sequence approximation functions that are stored in the summary memory step with the collective approximation function that has the collective domain that includes the range of sequence domains of the sequence approximation functions.

A recording medium according to a third aspect of the present invention is readable by a computer, and has a program being recorded thereon that causes a computer to execute:

an input step that inputs sequential data, which is data that is sequentially generated and comprises information that includes the order of generation and the value at that time, and accumulates that sequential data in a memory device every time the sequential data is generated;

a sequence summary step that, every time the sequential data is inputted, creates one of:

a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;

a sequence approximation function in which the sequence domain of the sequence approximation function that was created when the previous one inputted sequential data is extended up to the newly inputted sequential data, and the specified function parameter that was created when the previous one inputted sequential data is changed so as to approximate the values of the sequential data included in the extended sequence domain; or

a sequence approximation function in which the sequence domain of the sequence approximation function that was created when the previous one inputted sequential data is extended up to the newly inputted sequential data, and the specified function parameter that was created when the previous one inputted sequential data is maintained;

a summary memory step that stores the sequence approximation function that was created by the sequence summary step;

an accumulated data summary step that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and

a summary result evaluation step that replaces the sequence approximation functions that are stored in the summary memory step with the collective approximation function that has the collective domain that includes the range of sequence domains of the sequence approximation functions.

### Effect of the Invention

With the present invention it is possible to sequentially summarize data that is sequentially generated, as will as it is possible to eliminate time lag up to the start of analysis and improve the summary precision or summary rate.

### BRIEF DESCRIPTION OF DRAWINGS

FIG. 1 is a block diagram illustrating an example of the construction of a data summary system of a first embodiment of the present invention.

FIG. 2 is a drawing illustrating an example of sequential data of a first embodiment.

FIG. 3 is a drawing that expresses an example of sequential data in a graph.

FIG. 4 is a drawing that illustrates an example of processing when approximating the data illustrated in FIG. 3 using a linear function (y=ax+b).

FIG. 5 is a drawing illustrating an example of function parameters of a first embodiment.

FIG. 6 is a drawing that explains data summary using the sequence approximation function of a first embodiment.

FIG. 7 is a drawing that explains the case of changing only the defined domain of the sequence approximation function of a first embodiment.

FIG. 8 is a drawing that explains the case of changing the sequence approximation function of a first embodiment.

FIG. 9 is a drawing that explains the case of generating a new domain and parameters for the sequence approximation function of a first embodiment.

FIG. 10 is a drawing illustrating an example of sequential data that is the object of an accumulated data summary of a first embodiment.

FIG. 11 is a drawing that illustrates an example of processing in the case of approximating the data illustrated in FIG. 10 using a linear function.

FIG. 12 is an explanative drawing that expresses the state of extracting an angular point from the discrete curvature.

FIG. 13A is a drawing that illustrates an approximation function that was generated from sequential data.

FIG. 13B is a drawing that illustrates the sequential data in FIG. 13A.

FIG. 14A is a drawing that illustrates a sequence approximation function, which is the state before the sequential data undergoes accumulated data summarization.

FIG. 14B is a drawing that illustrates a collective approximation function that was generated from sequential data.

FIG. 14C is a drawing that illustrates the function parameters of the sequence approximation function in FIG. 14A.

FIG. 14D is a drawing that illustrates the function parameters of the collective approximation function in FIG. 14B.

FIG. 15 is a drawing that illustrates an example of the distance between the sequential data and the approximated function.

FIG. 16 is a drawing that illustrates an example of the function parameters stored in the summary result memory unit.

FIG. 17A is a drawing that illustrates an example of a request for data in a range that used in analysis.

FIG. 17B is a drawing that illustrates an example of function parameters that include a specified range.

FIG. 18 is a flowchart that illustrates an example of the data summary processing of a first embodiment.

FIG. 19 is a flowchart that illustrates an example of the sequence summary processing of a first embodiment.

FIG. 20 is a flowchart that illustrates an example of the operation of accumulated data summary processing of a first embodiment.

FIG. 21 is a block diagram that illustrates an example of the construction of a data summary system of a second embodiment of the present invention.

FIG. 22A is a drawing that illustrates a collective approximation function that is generated from sequential data.

FIG. 22B is a drawing that illustrates the minimum value of the function change threshold value in FIG. 22A.

FIG. 22C is a drawing that illustrates the maximum value of the function change threshold value in FIG. 22A.

FIG. 23 is a flowchart illustrating an example of the operation of data summary processing of a second embodiment.

FIG. 24 is a flowchart that illustrates an example of the operation of processing for adjusting the judgment criteria in a second embodiment.

FIG. 25 is a block diagram that illustrates an example of the construction of a data summary system of a third embodiment of the present invention.

FIG. 26A is a drawing that illustrates the function parameters of sequence approximation functions that are stored in the summary result memory unit.

FIG. 26B is a drawing that illustrates the function parameters of a collective approximation function that is inputted from the accumulated data summary unit.

FIG. 27 is a drawing that illustrates an example of compensating for the portion that is missing data due to deletion of function parameters of the sequence approximation function.

FIG. 28 is a flowchart that illustrates an example of the operation of the data summary processing of a third embodiment.

FIG. 29 is a block diagram that illustrates an example of the construction of a data summary system of a fourth embodiment of the present invention.

FIG. 30 is a flowchart that illustrates an example of the data summary processing of a fourth embodiment.

FIG. 31 is a block diagram that illustrates an example of the construction of a data summary system of a fifth embodiment of the present invention.

FIG. 32 is a flowchart that illustrates an example of operation of accumulated data summary of a fifth embodiment.

FIG. 33 is a block diagram that illustrates an example of hardware configuration of a data summary system of an embodiment of the present invention.

### BEST MODE FOR CARRYING OUT THE INVENTION

In the following, preferred embodiments of the present invention are explained in detail with reference to the accompanying drawings. In the drawings, the same reference numbers are assigned to identical or equivalent parts.

### Embodiment 1

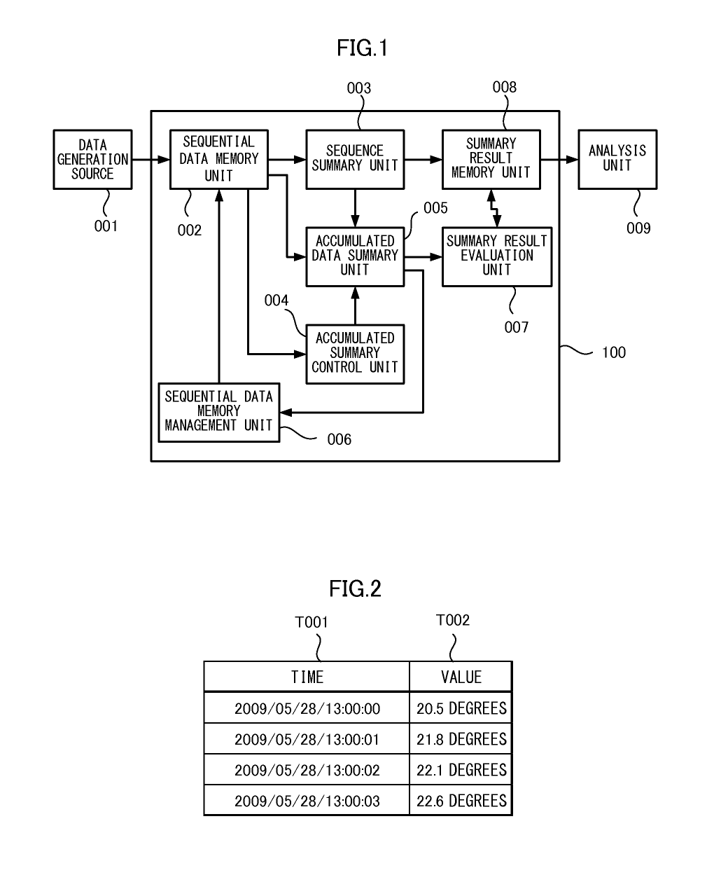

FIG. 1 is a block diagram that illustrates an example of the construction of a data summary system 100 of a first embodiment of the present invention. Sequential data that is sequentially generated from a data generation source 001 is inputted to the data summary system 100 that is illustrated in FIG. 1, and the data summary system 100 summarizes the sequential data each time sequential data is generated, and outputs the summary results to an analysis unit 009. The data summary system 100 comprises: a sequential data memory unit 002, a sequence summary unit 003, an accumulated summary control unit 004, an accumulated data summary unit 005, a sequential data memory management unit 006, a summary result evaluation unit 007 and a summary result memory unit 008.

In this embodiment, the data summary system 100 performs processing for summarizing data that the data generation source 001 generates sequentially. As will be described later, in this embodiment, “summarizing data” is finding parameters (hereafter, referred to as function parameters) that are necessary for identifying a function for approximating the value of data that is sequentially generated.

The data summary system 100 can be applied, for example, to an application of performing flow line analysis of Web access based on log data that is generated by Web data. Moreover, the data summary system 100 can be applied, for example, to an application of a traffic congestion information provision system that collects traffic information (for example, position information of automobiles on a road) and detects and provides the location of congestion on a road. The data summary system 100 can also be applied, for example, to an algorithm trading application that monitors the fluctuation in stock prices, matches the fluctuation in stock prices with selling and buying rules that are input in advance, and automatically sells or buys stocks. In other words, the data summary system 100 can be applied to all kinds of systems that sequentially generate a large amount of data, and perform analysis while reflecting the most recent data in real-time.

The data generation source 001 sequentially generates data. The data generation source 001 can be realized, for example, by a Web server that operates according to a program. Moreover, the data generation source 001 can be realized, for example, by a temperature sensor, humidity sensor or the like. The data generation source 001 comprises a function of outputting data that has some kind of order information and that is generated sequentially. In this embodiment, an example of the case of inputting data that is generated sequentially in a time series is explained; however, the data summary system can be applied as long as the data has some kind of order; for example, the system can be applied even in the case of sequentially inputting and analyzing data having a positional order, such as the order of closeness or farness of distance. Furthermore, application is not limited to data that is generated continuously in a short interval of time (for example, an interval of several seconds), and the data summary system can be applied as long as the data is generated sequentially, for example, the system can be applied to inputting and analyzing data in the case of data that is generated at long time intervals such as several hours or several days, or data for which the generating interval is not set.

The sequential data in this embodiment is data comprising information that includes the order of generation, and the values at that time. Information that includes the order of generation is information for arranging generated data in the order of generation, and is the order, time or distance at which the data is generated. When the interval at which data is generated is not a problem, then this information can be just the order. Information that includes the order of sequential data can be given by the data generation source 001, or can be given by the data summary system 100. Here, the distance (difference) of information that includes order from one sequential data to another sequential data is called an interval.

The object of the value of sequential data can be anything as long as the value at the time is uniquely determined. The value of sequential data can be a physical quantity such as current, voltage, electric power, temperature, pressure, force, position, displacement, momentum, brightness, luminance or the like. Moreover, the value, for example, could be an economic variable such as the price of a product. Furthermore, the value could be an index on the Internet such as the number of accesses, the number of views or the number of searches at a certain time. The value of sequential data is not limited to being one dimensional, and could be a vector. As long as order is given to the monotonic increase or decrease of elements, information that includes the order of generation could also be multi-dimensional. In this embodiment, an example is explained in which both information that includes order, and the value at that time are one dimensional.

In this embodiment, the data generation source 001 outputs sequential data that includes at least the time when the data was generated and the value. FIG. 2 illustrates an example of sequential data of this first embodiment. In the example of FIG. 2, the data generation source 001 outputs data that includes time T001 and value T002. Time T001 is the time at which the data outputted from the data generation source 001 was generated. The value T002 is the value (temperature in the example illustrated in FIG. 2) at the time the data was generated. In the following, for this embodiment, an example of a data generation source 001 that is achieved by a temperature sensor will be explained.

Sequential data that is outputted from the data generation source 001 is input to and stored in the sequential data memory unit 002 each time data is generated. When sequential data is inputted from the data generation source 001, the sequential data memory unit 002 stores that data, and at the same time outputs the sequential data to the sequence summary unit 003 in real-time at the time that the sequential data was generated.

The data that is stored in the sequential data memory unit 002 is referenced by the accumulated data summary unit 005. The amount of data that is stored in the sequential data memory unit 002 is referenced by the accumulated summary control unit 004. Moreover, the data that is stored in the sequential data memory unit 002 is deleted by the sequential data memory management unit 006. The operation of the sequential data memory management unit 006 will be explained in detail later.

The sequence summary unit 003 comprises a feature of using a function to execute a process of sequentially approximating sequential data that is outputted from the sequential data memory unit 002. In this embodiment, sequence approximation is generating one of the following three sequence approximation functions each time that sequential data is inputted.

(1) A sequence approximation function that comprises a sequence domain, which is a domain that starts from a point between previous one inputted sequential data and newly inputted sequential data and includes up to that newly inputted sequential data, and a specified function parameter that approximates the values of the previous one inputted sequential data and the newly inputted sequential data.

(2) A sequence approximation function in which a sequence domain of a sequence approximation function that was created when previous one sequential data was inputted is extended up to newly inputted sequential data, and a specified function parameter that was created when the previous one sequential data was inputted is changed so as to approximate the values of the sequential data included in the extended sequence domain.

(3) A sequence approximation function in which a sequence domain of a sequence approximation function that was created when previous one sequential data was inputted is extended up to newly inputted sequential data, and a specified function parameter that was created when the previous one sequential data was inputted is maintained.

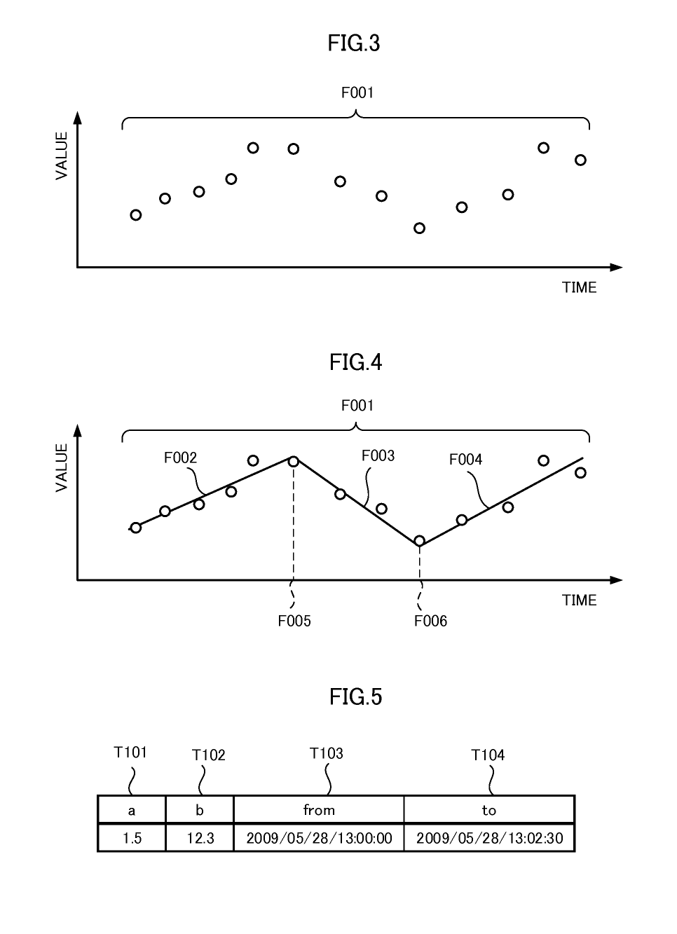

FIG. 3 expresses an example of sequential data in a graph, and illustrates an example of the case when data that was outputted from the sequential data memory unit 002 is plotted in a graph having time along the horizontal axis and values along the vertical axis. In FIG. 3, the group of points F001 illustrates each of the data that were outputted from the sequential data memory unit 002. The sequence summary unit 003 uses a function to execute processing for approximating the group of points F001 illustrated in FIG. 3 each time that sequential data is generated.

FIG. 4 illustrates an example of sequence summary results for the case when the group of points F001 illustrated in FIG. 3 are approximated using a linear function (y=ax+b). In the example illustrated in FIG. 4, the sequence summary unit 003 divides the group of points F001 into three domains, and performs approximation in each domain using the linear functions F002, F003 and F004. More specifically, the sequence summary unit 003 finds the necessary function parameters (slope ‘a’, and intercept ‘b’) and domain for specifying a linear function for each linear function F002, F003 and F004. The function domain is a range from among the entire range of sequentially generated data in which approximation using one specified function (here, this is a linear function) is possible.

In the example illustrated in FIG. 4, by using the function F003, it is possible to approximate the sequential data in a range between point F005 and point F006. The sequence summary unit 003 finds the domain of function F003 by defining point F005 as the starting point of the function F003, and point F006 as the ending point of function F003. The sequence summary unit 003 can similarly find the domains for function F002 and function F004. The boundary between adjacent domains such as point F005 and point F006 is called a domain dividing point.

A function domain is a parameter that indicates the range for which that function can be applied (the range for which approximation using that function is possible), and the slope ‘a’ and intercept ‘b’ are parameters that specify the function expression itself. Hereafter, the slope ‘a’ and intercept ‘b’ will be called the function expression specification parameters.

FIG. 5 is an explanative drawing illustrating an example of a function parameter in this first embodiment. As illustrated in FIG. 5, the function parameter comprises a parameter (a) T101 that expresses the slope of the linear function (y=ax+b), a parameter (b) T102 that expresses the intercept, a starting point (from) T103 of the function domain that is used in approximation, and an ending point (to) T104 of the domain. The group of the four parameters slope T101, intercept T102, domain starting point T103 and domain ending point T104 becomes one function parameter.

In this embodiment, an example of the sequence summary unit 003 using a linear function as the function for approximating the sequential data is explained; however, the sequence summary unit 003 is not limited to using a linear function as the function for approximating the sequential data. For example, the sequence summary unit 003 can perform processing for approximating sequential data using a high-dimensional function such as a two-dimension function or greater, or can perform processing for approximating sequential data using a function that includes a trigonometric function.

In FIG. 3, the group of points F001 is plotted in a graph beforehand, then FIG. 4 illustrates the results of using the three linear equations (F002, F003, F004) to approximate the group of points F001; however, actually, the data generation source 001 sequentially generates the data, so the sequence summary unit 003 sequentially performs processing for approximating the data using the functions every time that sequential data is generated. In other words, the sequence summary unit 003 sequentially sets functions to be used in the evaluating and approximating sequentially inputted sequential data in real-time each time sequential data is inputted, instead of using a function for performing processing for approximating data that was inputted in advance.

For example, as illustrated in FIG. 4, the function F004 is a function (hereafter called the most recent sequence approximation function) that is found by the function expression specification parameters that are newest in time, and is a function whose state is temporarily determined using data that was already generated in the past. The sequence summary unit 003 does not know what kind of value the next data has until new data has been inputted from the sequential data memory unit 002, so that in the future, whether the domain of the function F004 has been increased, or the function F004 has been corrected, or a new function has been created that comprises a domain that starts from a point between the previous one inputted sequential data and the newly inputted sequential data and function expression specification parameters in the domain is determined when new data is inputted.

When the next sequential data is a value whose approximation difference is a specified value or less when approximation was performed using function F004, the sequence summary unit 003 maintains the function expression specification parameters of function F004, and performs processing to extend the domain. When the next sequential data is a value whose approximation difference is within a specified range that exceeds a specified value when approximation is performed using function F004, the sequence summary unit 003 extends the domain of the function F004 up to the newly inputted sequential data, and performs processing on the sequential data that is included in the extended domain (sequential data of the domain before being extended, and the newly inputted sequential data) and corrects the function F004 using the least-squares method or the like. Moreover, when the next sequential data is a value whose approximation difference exceeds a specified range when approximation is performed using the function F004, the sequence summary unit 003 performs processing to stop approximation using the function F004, creates a new domain that starts at the ending point of the domain of the function F004 (divides the domain) and calculates (switches to a new function) function expression specification parameters (slope ‘a’ and intercept ‘b’) for approximating the sequential data of that domain.

As described above, the sequence summary unit 003 evaluates the sequential data that is sequentially inputted from the sequential data memory unit 002 every time that sequential data is inputted, and sequentially determines the function used for approximation. Therefore, the functions that are created by the sequence summary unit 003 for approximating sequential data are called sequence approximation functions. A sequence approximation function is expressed by a set of function expression specification parameters and a domain. The domain of a sequence approximation function is called a sequence domain.

The most recent sequence approximation function (function F004 illustrated in the example of FIG. 4) is in a temporary state in which the domain may be increased in the future, and the sequence summary unit 003 changes the parameters of that sequence approximation function according to sequential data that is inputted from the sequential data memory unit 002. On the other hand, sequence approximation functions that were created before the most recent sequence approximation function (function F002 and function F003 illustrated in the example in FIG. 4) are in a state in which the domain is already set, so that the sequence summary unit 003 will not change the parameters of those sequence approximation functions in the future.

The sequence summary unit 003 evaluates the inputted sequential data and internally has two kinds of judgment criteria values (function correction threshold value T1, function change threshold value T2) (hereafter, referred to as function switching judgment criteria values) for determining whether to perform processing to switch (divide the domain) to a new sequence approximation function to perform processing to increase the domain of the most recent sequence approximation function, or to perform processing to correct the most recent sequence approximation function. The sequence summary unit 003 also internally has the function parameter of the most recent sequence approximation function. Moreover, the sequence summary unit 003 has the sequential data from among the sequential data that are inputted from the sequential data memory unit 002 that are included in the domain of the most recent sequence approximation function. In other words, the sequence summary unit 003 stores a part of the original data.

The function switching judgment criteria values that are internally held by the sequence summary unit 003 can be defined in advance, or can be set arbitrarily by a user.

More specifically, the sequence summary unit 003 creates the sequence approximation function above based on newly inputted sequential data that is outputted from the sequential data memory unit 002, function switching judgment criteria values that are internally held by the sequence summary unit 003, function parameters of the previously generated sequence function and sequential data that is included in the domain of the previously generated sequence approximation function. The sequence summary unit 003 then stores the updated most recent function parameters in the summary result memory unit 008. Moreover, the sequence summary unit 003 deletes the function parameter held up to that time, and stores the newly updated most recent function parameter.

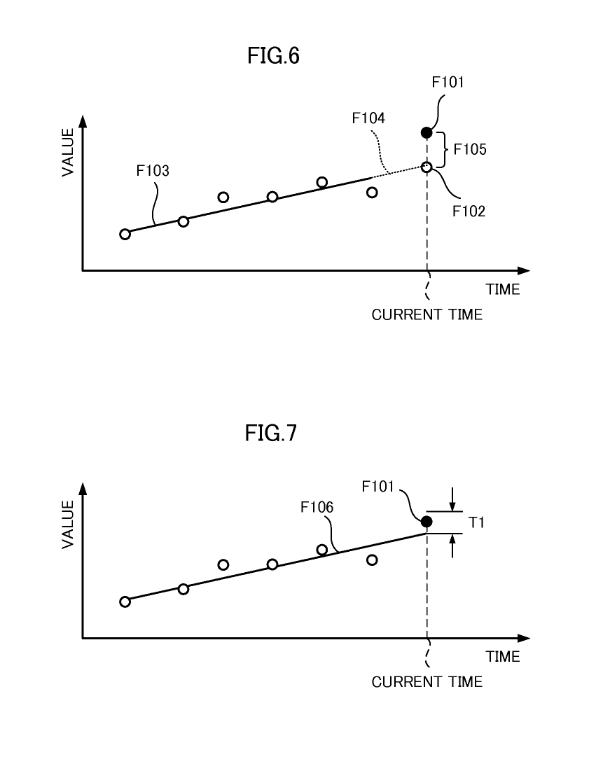

FIG. 6 is a drawing explaining the data summary according to the sequence approximation function of the first embodiment. FIG. 7 to FIG. 9 are explanative drawings that illustrate an example of the sequence summary unit 003 switching the function. In FIG. 6 to FIG. 9, the time that newly inputted sequential data is generated or inputted is expressed by the “current time”. In FIG. 6, point F101 indicates the value of data at the current time that is outputted from the sequential data memory unit 002 (hereafter, referred to as the real value). The solid straight line F103 is the previously generated sequence approximation function (function using the current approximation). The dotted line F104 illustrates the case when the domain of the previously generated sequence approximation function F103 is increased from the point of the previous one data to the current time. The point F102 indicates the value inputted and calculated at the current time (in other words, is the value of data that was estimated at the time the data was generated in the case where the sequence approximation function (straight line F103) that is used for the current approximation is extended as is. Hereafter, referred to as the calculated value) using the previously generated sequence approximation function. The distance F105 indicates the difference between the actual value and the calculated value.

The sequence summary unit 003 obtains (input) the actual value (point F101) from the sequential data memory unit 002. As a result, by inputting the time that the data was generated to function that is specified by using the internally held most recent function expression specification parameters, the sequence summary unit 003 calculates the calculated value (point F102). Next, the sequence summary unit 003 calculates the difference (distance F105) between the actual value (point F101) and the calculated value (point F102). The sequence summary unit 003 then compares the distance F105 between the actual value and calculated value with the function correction threshold value T1 of the internally held function switching judgment criteria values. Hereafter, the absolute value of the difference between the actual value and the calculated value will simply be called the difference.

FIG. 7 is a drawing explaining the case when changing only the domain of the sequence approximation function of the first embodiment. FIG. 7 illustrates an example of the case where the difference between the actual value and the calculated value (distance F105) is less than the function correction threshold value T1. When the difference between the actual value and the calculated value (distance F105) is less than the function correction threshold value T1, the sequence summary unit 003 determines that the approximation difference will be small even though the actual value (point F101) is approximated using the previously created sequence approximation function (straight line F103). As a result, the sequence summary unit 003 performs processing to increase the domain of the previously calculated sequence approximation function (straight line F103) up to the current time (more specifically, updates the ending point of the domain to the current time), and performs approximation using the same sequence approximation function (straight line F103) as is.

As illustrated in FIG. 7, when the difference between the actual value and the calculated value (distance F105) is equal to or less than the function correction threshold value T1, the sequence summary unit 003 performs processing to increase the domain of the previously generated sequence approximation function up to the current time. In FIG. 7, the straight line F106 indicates a function that is a result of increasing the domain of the sequence approximation function (straight line F103) that was previously created in FIG. 6 up to the current time.

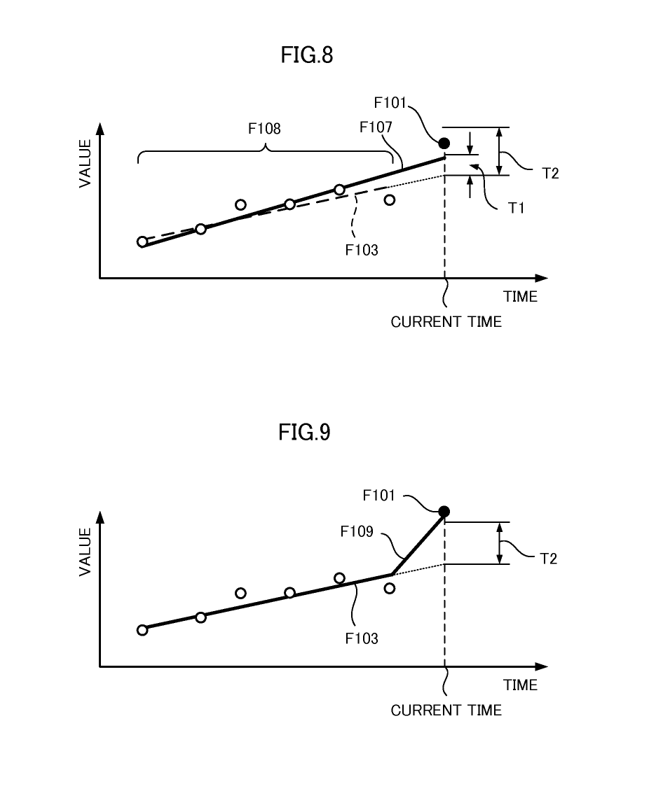

FIG. 8 is a drawing explaining the case of changing the sequence approximation function parameters in this first embodiment. When the difference between the actual value and calculated value (distance F105) is greater than the function correction threshold value T1 and equal to or less than the function change threshold value T2, the sequence summary unit 003 determines that the approximation difference will become greater when the actual value (point F101) is approximated using the sequence approximation function that was created when the previous one sequential data was inputted. Therefore, the sequence summary unit 003 performs correction of the sequence approximation function based on the sequence data newly inputted from the sequential data memory unit 002 and the data included in the domain of the internally held most recent function.

More specifically, correction by the sequence approximation function is a process that uses a method such as the least-squares method on the sequential data that is newly inputted from the sequential data memory unit 002 and the sequential data that is included in the domain of the internally head sequence approximation function that was previously created by the sequence summary unit 003 to recreate a function that will be used in current approximation (recalculates the function expression specification parameters).

In FIG. 8, the group of points F108 indicates data that is included in the domain of the previously generated sequence approximation function that is internally held in the sequence summary unit 003. The dashed straight line F103 is a function before correction for which the function expression specification parameters were calculated using the previous one sequential data and is the most recent function until the sequence summary unit 003 newly obtains (inputs) a new actual value (point F101). The straight line F107 is the function after the being corrected by the sequence summary unit 003.

In the example illustrated in FIG. 8, first the sequence summary unit 003 obtains (inputs) the actual value (point F101) and compares the difference (distance F105) between the calculated value and actual value with the function correction threshold value T1 and function change threshold value T2, and determines to perform correction of the sequence approximation function. The sequence summary unit 003 extends the domain of the sequence approximation function that was created when the previous one sequential data was inputted up to the current time. The sequence summary unit 003 then uses the least-squares method or the like on the sequential data that is included in the extended domain, or in other words, the actual value (point 101) and group of points F108, to recreate the function, and corrects the function from the sequence approximation function of the straight line F103 to the sequence approximation function of the straight line F107.

FIG. 9 is a drawing that explains the case when a new domain and parameters are created for the sequence approximation function in this first embodiment. FIG. 9 illustrates an example of the case when the difference between the actual value and the calculated value (distance F105) exceeds the function change threshold value T2. When the difference between the actual value and the calculated value (distance F105) exceeds the function change threshold value T2, the sequence summary unit 003 determines that the approximation difference will become large when approximating the actual value (point F101) using the previously calculated sequence approximation function (straight line F103) as is, or when approximating the actual value (point F101) by correcting the previously created sequence approximation function (straight line F103). As a result, the sequence summary unit 003 performs processing using a new function that connects with a straight line the actual value (point F101) and the end point of the domain of the sequence approximation function (straight line F103) that was created when the previous one sequential data was inputted in new approximation. More specifically, based on the actual value (point F101) and the value at the end point of the domain of the function of straight line F103, the sequence summary unit 003 finds function expression specification parameters (slope ‘a’ and intercept ‘b’) that can specify a function to be newly used in approximation.

As illustrated in FIG. 9, when the difference between the actual value and the calculated value (distance F105) is greater than the function change threshold value T2, the sequence summary unit 003 finds function expression specification parameters of a new function that connects with a straight line the actual value (point F101) and the value at the end point of the domain of the sequence approximation function (straight line F103) that was created when the previous one sequential data was inputted. In FIG. 9, the straight line F109 indicates a new function that connects with a straight line the actual value F101 and the value at the end point of the domain of the most recent straight line F103. After that, the sequence summary unit 003 uses the function of the new most recent straight line F109 instead of the function of the straight line F103 to perform processing to approximate the sequentially inputted data. After the function expression specification parameters of the new straight line F109 are calculated, the state (more specifically, the range of the domain) of the function of the straight line F103 is set, and after that, the state of the function of the straight line F103 is not changed by inputted data.

In the example in FIG. 9, the case is illustrated in which the sequence approximation function is set such that straight line F103 and the straight line F109 are continuous at the boundary between sequence domains. The function of the straight line F103 and the function of the straight line F109 do not have to be continuous at the boundary (dividing point) between sequence domains. In other words, it is possible to create a sequence approximation function such that the straight line F109 approximates the previous one inputted sequential data and the newly inputted sequential data without passing through the value at the end point of the domain of the straight line F103.

Moreover, the dividing point between domains does not have to be located at a position on the sequential data. The domain of the new sequence approximation function in FIG. 9 can start at a point between the previous one inputted sequential data and the newly inputted sequence data. In that case, the domain of the sequence approximation function that was created when the previous one sequential data was inputted is extended to that dividing point. The dividing point between domains can be the time at the point where the straight line F103 crosses the straight line F109 when a sequence approximation function is created that approximates the previous one inputted sequential data and the newly inputted sequential data without the straight line F109 passing through the value at the end point of the domain of the straight line F103.

When calculating new function expression specification parameters and switching the function, the sequence summary unit 003 performs control so that of the original data that is internally held by the sequence summary unit 003, the data from before the time when the new function expression specification parameters are calculated is deleted, so that the original data that is internally held by the sequence summary unit 003 is data that is included in the domain of the most recent function.

Operation such as the judgment procedure for the sequence summary unit 003 to determine whether to enlarge the function domain, correct the function or switch to a new function will be explained in detail below.

The accumulated summary control unit 004 in FIG. 1 controls the time of operation by the accumulated data summary unit 005. More specifically, the accumulated summary control unit 004 monitors the amount of data that has accumulated in the sequential data memory unit 002, and when the amount of data that is accumulated in the sequential data memory unit 002 is equal to or greater than a specified amount, outputs a notification instructing the accumulated data summary unit 005 to perform operation. The specified amount that acts as a trigger for the operation instruction for the accumulated data summary unit 005 can be a value that is set in advance, or can be set by the user.

The accumulated data summary unit 005 comprises a function that executes processing for approximating sequential data that is stored in the sequential data memory unit 002 using a specified function. However, the accumulated data summary unit 005 executes processing to obtain sequential data from among that sequential data that is stored in the sequential data memory unit 002 that is not the sequential data that is included in the domain of the most recent function for which the sequence summary unit 003 is executing approximation (data in the domain for which a sequence summary is being executed). Information that indicates the domain of the most recent function for which the sequence summary unit 003 is executing approximation is inputted from the sequence summary unit 003 when the accumulated data summary unit 005 starts processing.

When the accumulated data summary unit 005 is notified by an operation instruction from the accumulated summary control unit 004, the accumulated data summary unit 005 creates a function from sequential data of a specified range having continuous order that comprises a domain in which the range of information that includes that order is divided into one or two or more, and parameters of a specified function that approximates each of the values of the sequential data of the divided domain. The domain for which the accumulated data summary unit 005 divided the range of information that includes the order of sequential data of a specified range into one or two or more is called a collective domain. Moreover, the specified function that is created by the accumulated data summary unit 005 and that approximates the collective domain and the values of the sequential data in the collective domain is called a collective approximation function.

The accumulated data summary unit 005 collects together and approximates the sequential data of a specified range by a specified function, and outputs the function parameter to a summary result evaluation unit 007. When outputting the function parameter to the summary result evaluation unit 007, the accumulated data summary unit 005 also outputs the sequential data of the processing range to the summary result evaluation unit 007.

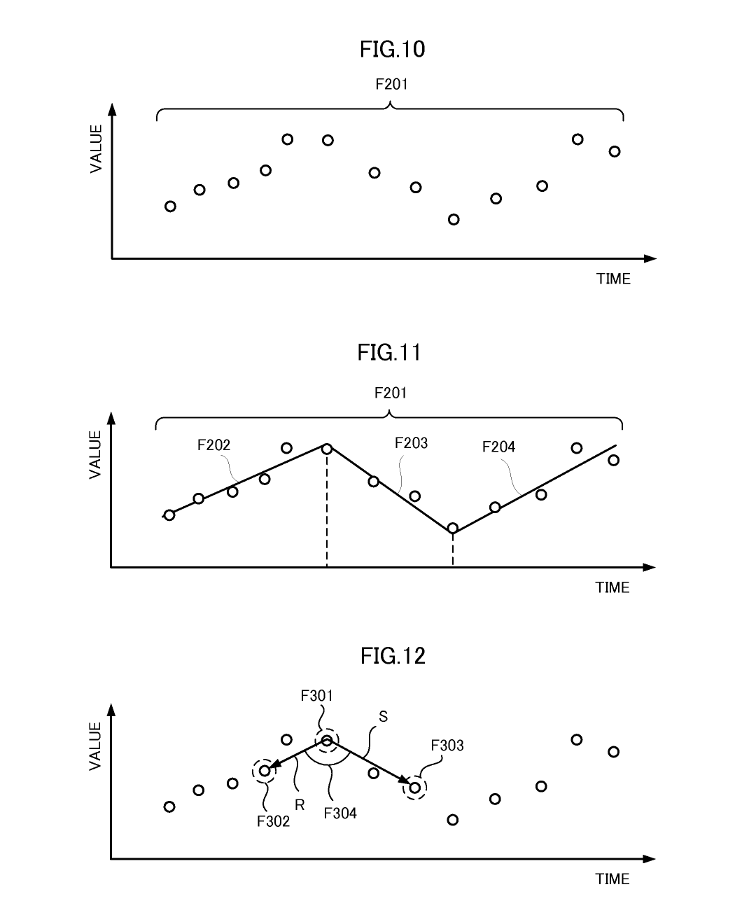

FIG. 10 illustrates an example of sequential data that is the object of the accumulated data summary of this first embodiment. FIG. 10 illustrates an example of the case where the sequential data array that is outputted from the sequential data memory unit 002 is plotted in a graph having time along the horizontal axis and values along the vertical axis. In FIG. 10, the group of points F201 indicates the sequential data array this was outputted from the sequential data memory unit 002. The accumulated data summary unit 005 executes processing for collectively approximating the sequential data array (group of points F201) illustrated in FIG. 10 using a specified function.

FIG. 11 illustrates an example of processing when the sequential data array (group of points F201) illustrated in FIG. 10 is approximated using a linear function (y=ax+b). In the example illustrated in FIG. 11, the accumulated data summary unit 005 approximates the sequential data array (group of points F201) using three linear functions, F202, F203 and F204. More specifically, the accumulated data summary unit 005 finds the necessary function parameters (slope ‘a’, intercept ‘b’ and domain) for specifying a linear function, for each of the linear functions F202, F203 and F204.

Several methods are possible as the method used by the accumulated data summary unit 005 to approximate a sequential data array that is outputted from the sequential data memory unit 002 using a function. For example, there is a method of approximating a sequential data array that is outputted from the sequential data memory unit 002 using one function that uses the least-squares method. In this method, a group of sequential data is approximated using one function, so that the summarization rate is high; however, error also becomes large. A method of deriving an approximation function using all of the patterns for all of the divisions and spots of divisions of the sequential data array is also possible. More specifically, when the number of sequential data that is inputted from the sequential data memory unit 002 is N (N is a natural number), the number of functions for approximating the N number of sequential data can be 1 to (N−1). Moreover, when the N number of sequential data are approximated by M number of functions (M is an integer that is 1 or more and (N−1) or less), the number of dividing points of the domain, or in other words, the number of points where the function is switched is M−1, and the number of methods for selecting the points where the function is switched is the number of combination of selecting M−1 number of dividing points from N−2 points (where the points on both ends are excluded)_{N-2}C_{M-1}. The approximation function could also be derived by all of the patterns of the number of divisions and spots of divisions. When using this method, all of the patterns are tried, so it is always possible to derive the most suitable approximation function. However, when the number N of sequential data that is inputted from the sequential data memory unit 002 becomes large, the number of ways for selecting the points for switching the function becomes extremely large, so that this method is not practical.

Therefore, in this first embodiment, a method is used in which the angular points are extracted according to the discrete curvature, and approximation is performed with a function that uses the least-squares method for each sequential data that is included in the area between angular points. Here, the angular point is a point from among the values of the discrete curvature that is a local maximum value, or is a point that has a value greater than a specified value. Hereafter, in this embodiment, an example is explained for the case in which the accumulated data summary unit 005 extracts the angular points according to the discrete curvature, and performs function approximation using the method of least squares for each sequential data that is included in the area between angular points.

FIG. 12 is an explanative drawing the expresses the state of extracting angular points according to the discrete curvature. In FIG. 12, the point F301 is a judgment point that is focused on when determining whether or not a point is an angular point. Point F302 indicates a point that is k intervals before the judgment point (k is a natural number, and k=2 in the example illustrated in FIG. 12). Point F303 indicates a point that is k intervals after the judgment point. Angle F304 indicates the angle (0 to π radians) between the vector R from point F301 to point F302 and the vector S from point F301 to point F303, where the cosine of the angle F304 is a characteristic amount called the discrete curvature. The discrete curvature is equal to the inner product of vector R and vector S that are each normalized to a unit vector. A characteristic of the discrete curvature is that it takes on a value near −1 when the sequence of points extends in a straight line, takes on a value of 0 when bent at a right angle, and takes on a value of 1 when bent at an acute angle.

From the above description, discrete curvature can be calculated in order from the point on the left end, which is the oldest sequential data on the time axis (technically, from the (k+1)th point from the left end) to the point on the right end, which the newest sequential data on the time axis (technically, to the (k−1)th point from the right end), and the point where the discrete curvature value is greater than a specified value is taken to be the local maximum and can be extracted as an angular point. By extracting all of the angular points of the sequential data that is included in the target range, data is approximated by a specified function that used the least-squares method on a point sequence inside the area between angular points. Technically, the points on both ends of the point sequence are not angular points, however processing is executed by taking them to be angular points.

When the number of intervals k used for calculating the discrete curvature is set to a small value, the effect of noise is easily received, and when set to a large value, it becomes difficult to detect adjacent angular points. The value of the number of intervals k can be set in advance, or can be arbitrarily set by the user. Moreover, a specified value (hereafter, referred to as the angular point extraction reference value) for setting how large of a value the value of the discrete curvature will become to be extracted as an angular point can be set in advance, or can be arbitrarily set by the user.

In this first embodiment, an example of the case of the accumulated data summary unit 005 using a linear function as the function for approximating data is explained, however, the function that is used by the accumulated data summary unit 005 for approximating data is not limited to being a linear function. For example, the accumulated data summary unit 005 can perform processing for approximating data using a high dimensional function such as a two-dimensional function or greater, or can perform processing for approximating data using a function that includes a trigonometric function. Moreover, a collective approximation function and a sequence approximation function do not have to be the same type of function.

The sequential data memory management unit 006 comprises a function for deleting the data of the sequential data memory unit 002. More specifically, when the accumulated data summary unit 005 performs accumulated data summary processing to approximate data stored in the sequential data memory unit 002 using a function, a notification informing that processing was executed is received from the accumulated data summary unit 005, and the sequential data memory management unit 006 deletes data that is stored in the sequential data memory unit 002 for which the accumulated data summary unit 005 executed processing. More specifically, the sequential data memory management unit 006 releases the memory area for sequential data in the sequential data memory unit 002 that was the target of accumulated data summary processing, such that new sequential data can be stored in that area.

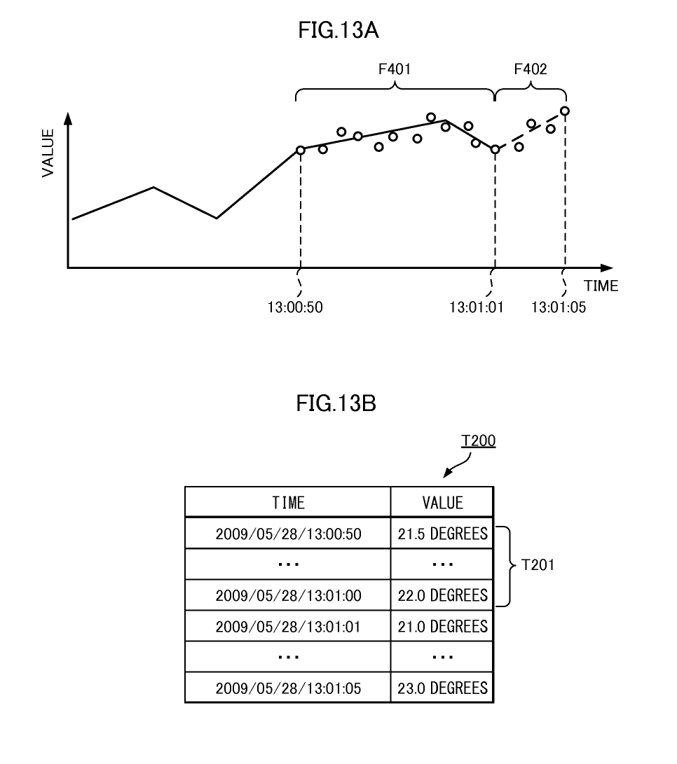

FIG. 13A and FIG. 13B are drawings that illustrate an example of the sequential data memory management unit 006 causing sequential data that is stored in the sequential data memory unit 002 and for which the accumulated data summary unit 005 executed processing to be deleted. FIG. 13A is a drawing that illustrates an approximation function that was created from sequential data. FIG. 13B is a drawing that illustrates the sequential data in FIG. 13A. As illustrated in FIG. 13A, the group of points F401 and group of points F402 are sequential data that are stored in the sequential data memory unit 002. The sequential data expressed by the group of points F402 is sequential data that is included in the domain of the most recent function and for which the sequence summary unit 003 is executing approximation processing.

The accumulated data summary unit 005 processes the data stored in the sequential data memory unit 002 that is not sequential data that is included in the domain of the most recent function for which the sequence summary unit 003 executes approximation processing, so that in the example in FIG. 13A, the sequential data of the group of points F401 become the object of processing of the accumulated data summary unit 005. After the sequential data of the data group F401 undergoes collective summary processing by the accumulated data summary unit 005, the sequential data memory management unit 006 receives notification information from the accumulated data summary unit 005 informing that processing has been executed, and as illustrated in FIG. 13B, of the sequential data T200 that is stored in the sequential data memory unit 002, causes sequential data T201 for which processing has been executed by the accumulated data summary unit 005 to be deleted.

The summary result evaluation unit 007 compares the sequence approximation function that was created by the sequence summary unit 003 with the collective approximation function created by the accumulated data summary unit 005, and when the collective approximation function is better approximation, deletes the sequence approximation function that is stored in the summary result memory unit 008, and in its place, stores the collective approximation function that was created by the accumulated data summary unit 005 in the summary result memory unit 008.

More specifically, first, after the collective approximation function created by the accumulated data summary unit 005 has been inputted, the summary result evaluation unit 007 reads the sequence approximation function for the same domain as the collective approximation function from among the sequence approximation functions stored in the summary result memory unit 008.

At the instant when the collective approximation function that was created by the accumulated data summary unit 005 is inputted to the summary result evaluation unit 007, the sequential data that is included in the domain (collective domain) of the collective approximation function is already undergoing function approximation by the sequence summary unit 003. This is because the sequence summary unit 003 approximates sequential data using a function every time that sequential data is inputted. Therefore, when the summary result evaluation unit 007 reads the sequence approximation function for the range having the same domain as the collective approximation function from among the sequence approximation function stored in the summary result memory unit 008, the problem of the sequence approximation function in question not existing does not occur.

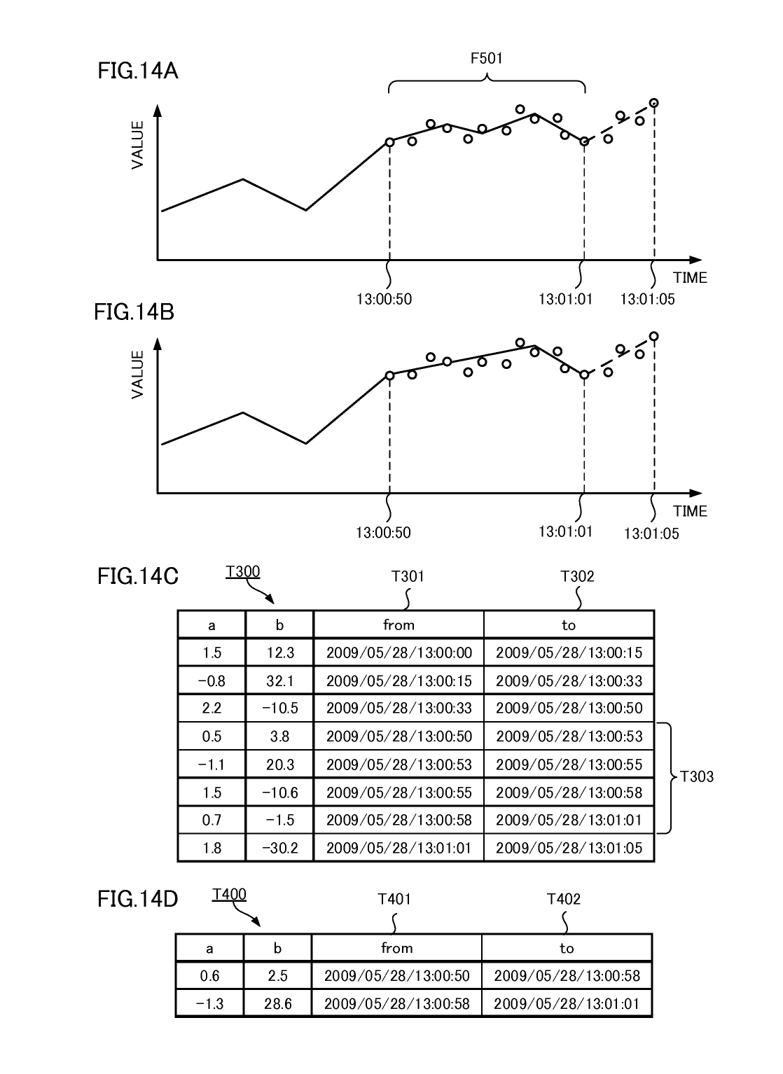

FIG. 14A to FIG. 14D illustrate an example of a collective approximation function being inputted from the accumulated data approximation unit 005 and the summary result evaluation unit 007 reading the sequence approximation function having the same domain as the collective approximation function from the summary result memory unit 008. FIG. 14A illustrates the state before the sequential data of the group of points F501 undergo accumulated data summarization by the accumulated data summary unit 005, or in other words, illustrates the sequence approximation function that was created by the sequence summary unit 003. FIG. 14B illustrates the collective approximation function that was created by the accumulated data summary unit 005 from the sequential data of the group of points F501. FIG. 14C illustrates the function parameters T300 of the sequence approximation function stored in the summary result memory unit 008 in the state illustrated in FIG. 14A. FIG. 14D illustrates the function parameters T400 of the collective approximation function that was created by the accumulated data summary unit 005 from the sequential data. After the function parameters T400 have been inputted from the accumulated data summary unit 005, the summary result evaluation unit 007 searches for the function parameters in the same range as the domain of the function parameters T400 from among the function parameters T300 stored in the summary result memory unit 008. More specifically, the summary result evaluation unit 007 searches among the starting points (from) T301 of the domain of the function parameters T300 for the value having the same value as the starting point with the oldest time (“2009/05/28/13:00:50” in the example illustrated in FIG. 14D) among the starting points (from) T401 of the domain of the function parameters T400, and stores the position of the record having the same value. Next, the summary result evaluation unit 007 searches among the ending points (to) T302 of the domain of the function parameters T300 for the value having the same value as the ending point with the newest time (“2009/05/28/13:01:01” in the example illustrated in FIG. 14D) among the ending points (to) T402 of the domain of the function parameters T400, and stores the position of the record having the same value. The function parameters T303 that are between the positions of the two records above are the function parameters that are read from the summary result memory unit 008.

The summary result evaluation unit 007 evaluates the function parameter of the collective approximation function that was outputted by the accumulated data summary unit 005, and the function parameters of the sequence approximation function that was read from the summary result memory unit 008 according to the aspect of summary precision and/or summary rate. The summary precision can be defined by the sum of the distances between the values of the sequential data and the approximated function values. The smaller the sum of the distances between the original data and the approximated function is, the smaller the error is, so that the precision can be said to be high. The summary rate is set by the number (number of domain divisions) of functions that approximated data. The summary rate can be said to be higher the smaller the number of domain divisions is.

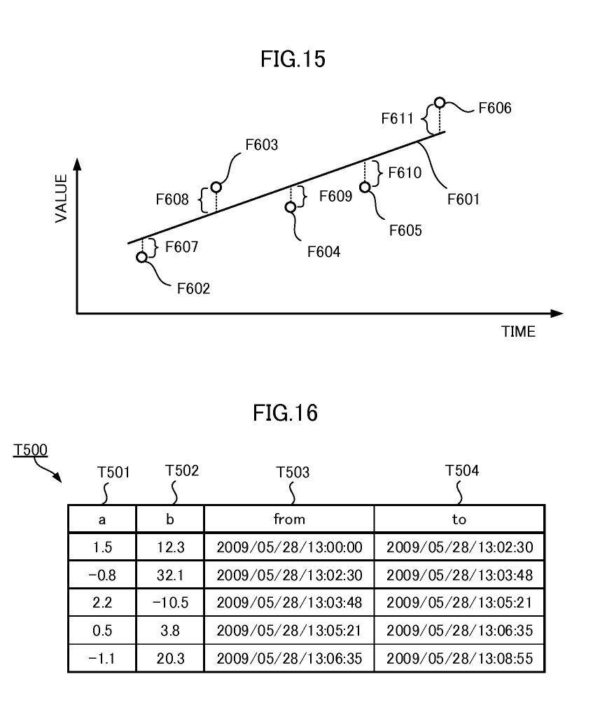

FIG. 15 illustrates an example of the distances between the sequential data and the approximated function. The straight line F601 expresses the function that approximated data, and points F602 to F606 express the sequential data. The distances between the function (sequence approximation function or collective approximation function) that is indicated by the straight line F601 and the sequential data that are indicated by points F602 to F606 are indicated by distances F607 to F611. As illustrated in FIG. 15, the distances between the sequential data and the approximated function correspond to the lengths of line segments when straight lines are drawn along the vertical axis from the sequential points to the function.

When the summary result evaluation unit 007 evaluates the function parameters that were outputted by the accumulated data summary unit 005 and the function parameters that were read from the summary result memory unit 008, an evaluation function that is based on the summary precision and the summary rate, such as given below, can be used.

w1/A+w2/S Evaluation function:

In the evaluation function, variable A is the number of approximation functions (divided domain). The summary rate increases the smaller the number of approximation functions there is, so that the first term is a value that becomes larger the smaller the value of A is. Variable S is the sum of distances between the sequential data and the approximation functions. The error becomes less and the precision becomes higher the smaller the sum of the distances between the sequential data and approximation functions is, so that the second term of the evaluation function is a value that becomes larger the smaller the value of S is. The parameters w1 and w2 are weighted constants. The higher the value that parameter w1 is set to, the more the evaluation function emphasizes the summary rate of the first term, and the higher the value that the parameter w2 is set to, the more the evaluation function emphasizes the precision of the second term. The values of the parameters w1 and w2 can be set in advance, or can be arbitrarily set by the user.

The summary result evaluation unit 007 uses the evaluation function to calculate the evaluation values from evaluating the collective approximation function that was outputted from the accumulated data summary unit 005 and the sequence approximation function that was read from the summary result memory unit 008, and compares the evaluation values. If the evaluation value of the function parameters of the collective approximation function is greater than the evaluation value of the function parameters of the sequence approximation function, it can be said that the function parameters that are outputted by the accumulated data summary unit 005 are good function parameters, so that of the function parameters of the sequence approximation function that are stored in the summary result memory unit 008, the function parameters of a sequence approximation function having a domain (sequence domain) that corresponds to the domain of the collective approximation function (collective domain) are deleted and the function parameters of the collective approximation function are newly stored. When doing this, the order of the function parameters that are stored in a list, is arranged based on time. In other words, the domains of the function parameters in the list are stored such that they become older in time.

In the example in FIG. 14A to FIG. 14D, the sequential data that was approximated by the sequence summary unit 003 using a sequence approximation function of a domain that was divided into four (sequence domain) is approximated by the accumulated data summary unit 005 using a collective approximation function of a domain that was divided in two (collective domain). In this way, the number of function parameters (number of domain divisions) that are stored by the summary result memory unit 008 is reduced. In other words, there are cases in which the summary rate becomes high (there are also cases when the precision rises at the same time), and conversely, there are also cases in which the number of function parameters (number of domain divisions) stored by the summary result memory unit 008 increases, or in other words, the precision becomes high. This changes according to whether the summary rate is emphasized or the precision is emphasized in the evaluation equation.

When the summary result evaluation unit 007 performs evaluation, it is not absolutely necessary to use the evaluation function above, and evaluation can be performed based on any standard made from the summary precision and/or summary rate. When, for the collective approximation function, the summary precision is low (the sum of errors is large), and the summary rate is low (the number of domain divisions is large), it is preferred that at least the sequence approximation function is not replaced with the collective approximation function. In other words, it is preferred that replacing the sequence approximation function with the collective approximation function be limited to the case in which for the collective approximation function, the summary precision is high, or the summary rate is high.

The summary result memory unit 008 stores the function parameter of the sequence approximation function that is created by the sequence summary unit 003, or the function parameter of the collective approximation function that is created by the accumulated data summary unit 005 in a memory device. FIG. 16 illustrates an example of function parameters that are stored by the summary result memory unit 008. As illustrated in FIG. 16, the summary result memory unit 008 stores a parameter (a) T501 that expresses the slope of a linear function (y=ax+b), a parameter (b) T502 that expresses the intercept, a starting point (from) T503 of the domain of the approximating function, and the ending point (to) T504 of the domain, as function parameters. The set of these four parameters, the slope T501, the intercept T502, the domain starting point T503 and domain ending point T504 becomes one function parameter.

In FIG. 16, an example is illustrated of the case in which the sequence summary unit 003 or accumulated data summary unit 005 uses a linear function for approximating sequential data; however, the function used for approximating sequential data is not limited to being a linear function. For example, the sequence summary unit 003 or accumulated data summary unit 005 can use a high-dimensional function such as a two-dimensional function or greater as the function used for approximating sequential data, or can use a function that includes a trigonometric function or the like. In such a case as well, the summary result memory unit 008 stores a set of function expression specification parameters (parameters corresponding to parameters a and b in the example of a linear function. The amplitude, angular frequency and phase in the case of a trigonometric function.), the domain starting point (from) of a function, and the domain ending point (to) as one function parameter.

The sequence summary unit 003 performs processing to sequentially approximate data along the time axis using a function, so as illustrated in FIG. 16, a table T500 of function parameters is stored in the summary result memory unit 008 in a state arranged in order of time (ascending order or descending order). In other words, the starting point (from) T503 and the ending point (to) T504 of the ith (i is a natural number) record in the function parameter table T500 are stored in the summary result memory unit 008 in a state such that they are arranged so that they are older in time than the starting point (from) T503 and the ending point (to) T504 of the (i+1)th record.

Moreover, the summary result memory unit 008 comprises a function of response sending (outputting) parameters that include a range specified by the analysis unit 009 as the summary result of data that was sequentially inputted from the data generation source 001 to the analysis unit 009 as a response to a request from an analysis unit 009.

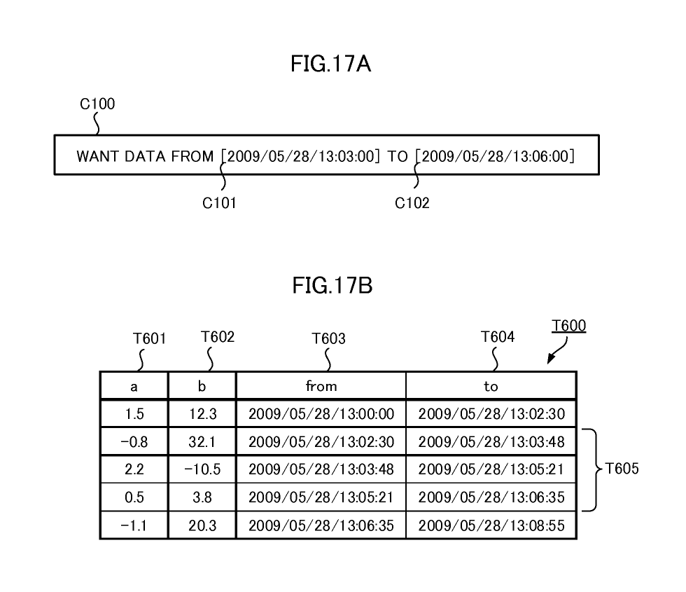

FIG. 17A and FIG. 17B illustrate an example of a request from the analysis unit 009 to the summary result memory unit 008 for data in the range used for analysis, and a response from the summary result memory unit 008 to the analysis unit 009 of function parameters that include the specified range. Of these, FIG. 17A illustrates an example of an analysis request from the analysis unit 009. FIG. 17B illustrates an example of summary results that are output from the summary result memory unit 008.

As illustrated in FIG. 17A, the analysis unit 009 sends a request to the summary result memory unit 008 for data (summary results) in the range used for analysis. More specifically, the analysis unit 009 outputs an output request C100 to the summary result memory unit 008. In the example illustrated in FIG. 17A, in order to make the explanation easier to understand, the output request C100 is expressed using close to natural language, however, actually, when mounted in a computer, the analysis unit 009 outputs an output request C100 as a query that is created using a computer language such as SQL language.

The analysis unit 009 outputs an output request C100 to the summary result memory unit 008 that includes, for example, a parameter C101 that expresses the starting point of the requested range, and a parameter C102 that expresses the ending point of the requested range. The summary result memory unit 008 uses the two parameters C101 and C102 that are included in the output request C100 to search for and extract the corresponding function parameters from the function parameter table T600 illustrated in FIG. 17B.

First, the summary result memory unit 008, in order to check whether or not the data that was requested by the analysis unit 009 exists in the function parameter table T600, compares the value of the starting point (from) T603 of the first record of the table T600 with value of the value of the parameter C102. When doing this, in the case that the value of the starting point (from) T603 of the first record of the table T600 is determined to be a newer value in terms of time than the value of the parameter C102, the requested data does not exist, so that the summary result memory unit 008 outputs notification information to the analysis unit 009 notifying that the data does not exist.

Next, the summary result memory unit 008 compares the value of the ending point (to) T604 of the last record of the table T600 with the value of parameter C101. When doing this, when the value of the ending point (to) T604 of the last record of table T600 is determined an older value in terms of time than the value of the parameter C101, the requested data does not exist, so that the summary result memory unit 008 outputs notification information to the analysis unit 009 notifying that the data does not exist.

When as a result it was not determined in both of the two comparison processes of the starting point and ending point that the data does not exist, then the data requested by the analysis unit 009 does exist in the table T600. In that case, the summary result memory unit 008 searches for that data.

The summary result memory unit 008 performs processing to compare in order from the first value of the table T600 the value of the parameter C101 and the value of the ending point (to) T604. The summary result memory unit 008 searches for and identifies the first record whose ending value (to) T604 is newer in terms of time than the parameter C101.

Next, the summary result memory unit 008 performs processing to compare in order from the first value of the table T600 the value of the parameter C102 and the value of the ending point (to) T604. The summary result memory unit 008 searches for and identifies the first record whose ending value (to) T604 is newer in terms of time than the parameter C102.

Next, the summary result memory unit 008 identifies a record between the record found by comparing parameter C101 and ending point (to) T604 and the record found by comparing parameter C102 and ending point (to) T604. The summary result memory unit 008 sends (outputs) the value of that identified record to the analysis unit 009 as the requested function parameter.

When no corresponding records are found when comparing the parameter C102 and the value of the starting point (from) T603 in order from the first value of the table T600, the summary result memory unit 008 identifies a record between the record found by comparing the parameter C101 and ending point (to) T604 and the last record of the table T600. The summary result memory unit 008 then sends (outputs) the value of that identified record to the analysis unit 009 as the requested function parameter.

The example in FIG. 17B illustrates the case in which the summary result memory unit 008 sends (outputs) function parameters T605 that are included in three records that include the specified range as a response to an output request C100 from the analysis unit 009.

More specifically, the analysis unit 009 is achieved by the CPU (Central Processing Unit) of a computer that operates according to a program, and is a unit that performs various kinds of analysis. The analysis unit 009 comprises a function for requesting function parameters in a range used for analysis from the summary result memory unit 008. The analysis unit 009 also has a function that performs various kinds of analysis based on the function parameters that are returned (outputted) by the summary result memory unit 008 in response to the request.

For example, the analysis unit 009 performs line of flow analysis of Web access based on log data that is generated by a Web server. Moreover, the analysis unit 009 can, for example, analyze and detect areas of traffic congestion on a road based on collected data of traffic information (for example, position information of automobiles on a road). Furthermore, the analysis unit 009 can, for example, based on stock price change information, analyze whether or not it is time to buy or sell stock matching the change in stock prices with buying and selling rules.

When the analysis unit 009 requests that the summary result memory unit 008 send function parameters that include a specified range, the analysis unit 009, as illustrated in FIG. 17A and FIG. 17B outputs an output request C100 that includes parameter C101, which expresses the starting point of the specified range, and parameter C102, which expresses the ending point of the specified range, to the summary result memory unit 008. The analysis unit 009 then performs analysis based on the function parameters T605 that are returned (outputted) in response to the output request C100.

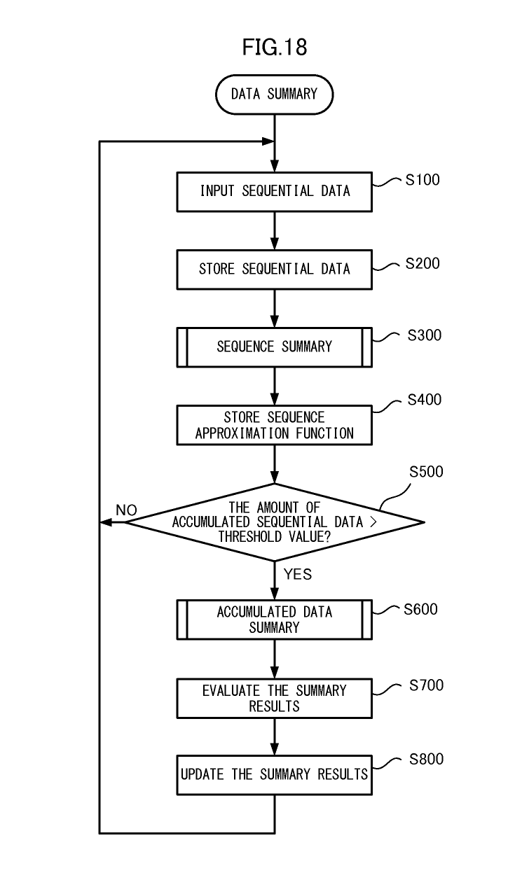

FIG. 18 is a flowchart illustrating an example of the data summary process of this first embodiment. As illustrated in FIG. 18, in this first embodiment, the operation steps of the data summary system 100 include: a step of inputting sequential data (step S100), a step of storing sequential data (step S200), a sequence summary step (step S300), a step of storing sequence approximation functions (step S400), a step of determining whether or not the amount of data stored in the sequential data memory unit 002 is equal to or greater than a threshold value (step S500), an accumulated data summary step (step S600), a summary result evaluation step (step S700) and a summary result analysis step (step S800).

After the data generation source 001 sequentially generates data, the sequential data is input to the sequential data memory unit 002 from the data generation source 001 every time data is generated (step S100). At the same time that the sequential data memory unit 002 stores the inputted data, the sequential data memory unit 002 outputs that inputted sequential data to the sequence summary unit 003 (step S200). Every time that sequential data is inputted from the sequential data memory unit 002, the sequence summary unit 003 summarizes the inputted sequential data, executes processing to create a sequence approximation function, and outputs the function parameter of the sequence approximation function to the summary result memory unit 008 (step S300).

The summary result memory unit 008 stores the function parameter of the sequence approximation function. When the function parameter domain that was stored the previous time is the same as the function parameter domain inputted the current time (the starting point of the sequence domain is the same), the summary result memory unit 008 updates the function parameter stored the previous time with the function parameter inputted this current time. When the previous and current domains are not the same (when the starting points of the sequence domains are different), the function parameter that is inputted the current time is added and stored.

The accumulated summary control unit 004 monitors the amount of sequential data that is stored in the sequential data memory unit 002, and when the accumulated amount of sequential data has exceeded a threshold value (step S500: YES), outputs an operation instruction to the accumulated data summary unit 005. On the other hand, when the accumulated amount of sequential data does not exceed a threshold value (step S500: NO), processing returns to step S100 and sequential data is inputted from the data generation source 001. The accumulated data summary unit 005 receives an operation instruction from the accumulated summary control unit 004, executes summary processing on the data stored in the sequential data memory unit 002, and outputs a function parameter of a collective approximation function to the summary result evaluation unit 007 (step S600).

The summary result evaluation unit 007 evaluates the summary result (function parameters) from the sequence summary unit 003 and accumulated data summary unit 005 according to an evaluation function that was created from the aspect of summary precision or summary rate (step S700). When the evaluation value of a collective approximation function that was inputted from the accumulated data summary unit 005 is a higher value, the summary result evaluation unit 007 outputs the function parameter of the collective approximation function to the summary result memory unit 008.

After the function parameter of the collective approximation function that was created by the accumulated data summary unit 005 is inputted from the summary result evaluation unit 007, the summary result memory unit 008 deletes the function parameters of sequence approximation functions having a domain that is included in the same domain as the function parameter of the inputted collective approximation function, and stores the function parameter of the inputted collective approximation function (step S800).

After function parameters in the range used for analysis have been requested from the analysis unit 009, the summary result memory unit 008 sends (outputs) the function parameters in the requested range as a response to the analysis unit 009. The request from the analysis unit 009 and the response (output) from the summary result memory unit 008 are performed independently and asynchronous to the data summary.

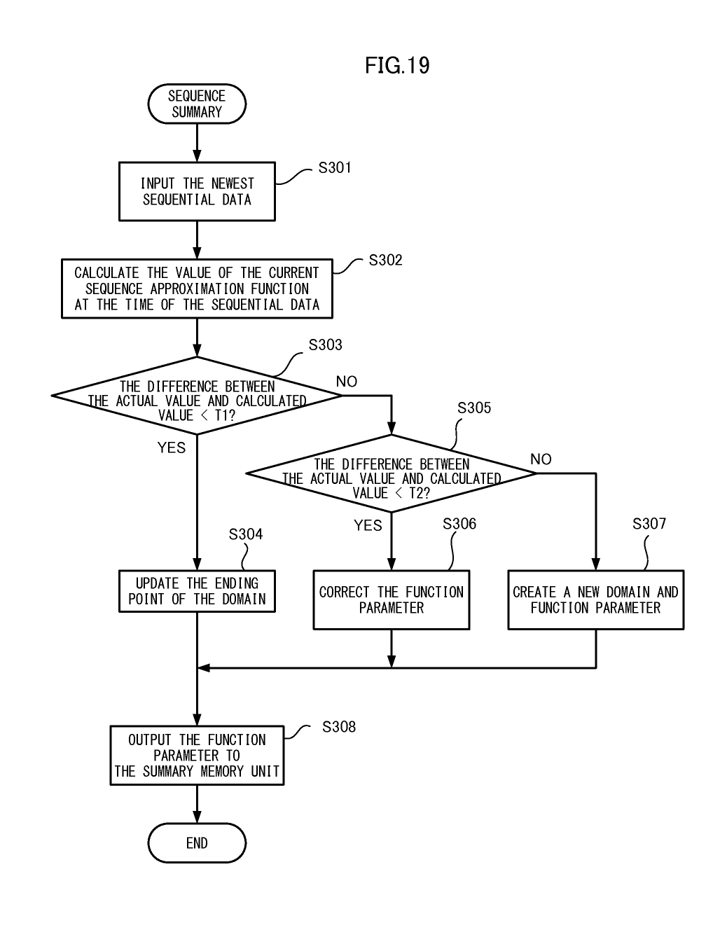

FIG. 19 is a flowchart illustrating an example of the sequence summary process of this first embodiment. The processing illustrated in FIG. 19 illustrates the contents of step S300 in FIG. 18. The most recent sequential data that is outputted from the sequential data memory unit 002 is input to the sequence summary unit 003 (step S301). As a result, the sequence summary unit 003 inputs the time of the sequential data to a function that is specified by the internally stored current function expression specification parameters, and calculates the calculated value (step S302).

Next, the sequence summary unit 003 compares the practical value (actual value) of the sequential data obtained (inputted) from the sequential data memory unit 002 and the calculated value that was calculated in step S302. In this case, the sequence summary unit 003 determines whether or not the difference between the actual value and the calculated value is less than a function correction threshold value T1, which is a first function switching judgment criteria value that is internally stored (step S303).

When the difference between the actual value and the calculated value is determined to be less than the function correction threshold value T1 (step S303: YES), the sequence summary unit 003 updates the domain ending point (to) of the sequence approximation function that was created when the sequential data just before was inputted to the time of newly inputted sequential data (step S304). When the difference between the actual value and the calculated value exceeds the first function correction threshold value T1 that is stored internally (step S303: NO), the sequence summary unit 003 determines whether or not the difference between the actual value and the calculated value is less than a function change threshold value T2, which is a second function switching judgment criteria value that is internally stored (step S305).

When the difference between the actual value and the calculated value is less than the function change threshold value T2 (step S305: YES), the sequence summary unit 003 performs correction of the parameter of the sequence approximation function that was created when the previous one sequential data was inputted (step S306). In other words, the sequence domain of the sequence approximation function that was created when the previous one sequential data was inputted is extended to the sequential data that was newly inputted, and the parameters of the sequence approximation function that was created when the previous one sequential data just one before was inputted are updated so that the values of sequential data included in the extended sequence domain are approximated. More specifically, the sequence summary unit 003 recalculates the function expression specification parameter using the least-squares method or the like for the newly inputted sequential data and for the sequential data that is included in the domain of the internally stored sequence approximation function.

When the difference between the actual value and the calculated value exceeds the function change threshold value T2 (step S305: NO), the sequence summary unit 003 creates a new domain (sequence domain) that starts from a point between the previous one inputted sequential data and the newly inputted sequential data and goes to the newly inputted sequential data, and creates a sequence approximation function that comprises a specified function parameter that approximates the values of the previous one inputted sequential data and the newly inputted sequential data (step S307). For example, the sequence summary unit 003 calculates new function expression specification parameters (slope ‘a’ and intercept ‘b’) using the newly inputted sequential data and the ending point (to) of the domain of the previously created sequence approximation function.

Next, the sequence summary unit 003 outputs the function parameter that was updated in step S304, step S306 or step S307 (slope ‘a’, intercept ‘b’ and domain) to the summary result memory unit 008 (step S308).

It is not illustrated in the flowchart in FIG. 19, however, in the initial state when there is still no function parameter stored in the summary result memory unit 008, the sequence summary unit 003 performs buffering until several sequential data have been inputted from the sequential data memory unit 002. The sequence summary unit 003 can then find the function parameter of the first function to be used in approximation by using the method of least squares on some of the buffered data.

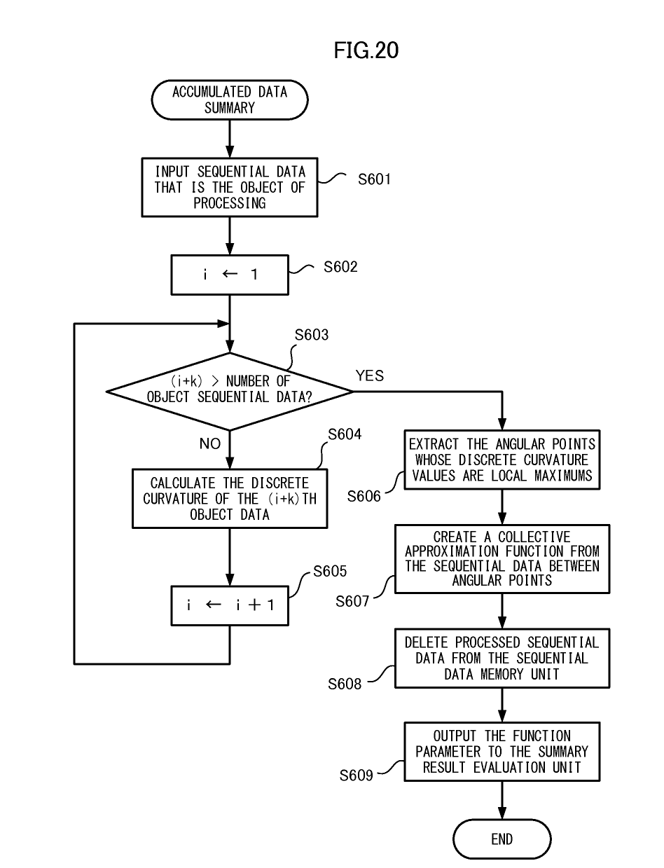

FIG. 20 is a flowchart that illustrates an example of the operation of the accumulated data summary process of this first embodiment. FIG. 20 illustrates the contents of step S600 in FIG. 18. First, sequential data that is the object of processing is input to the accumulated data summary unit 005 from the sequential data memory unit 002 (step S601). Here, the sequential data that is the object of processing is sequential data that is stored in the sequential data memory unit 002 and that does not include sequential data that is included in the domain of the most recent function for which the sequence summary unit is executed approximation processing.

Next, the accumulated data summary unit 005 substitutes 1 for variable i (step S602). Then, the accumulated data summary unit 005 determines whether or not the value (i+k) is larger than the number of sequential data that is the object of processing (step S603). Here, the variable k is the number of intervals used when calculating the discrete curvature described above. The discrete curvature is calculated from the cosine of the vector that connects the sequential data at the judgment point and sequential data that is separated from the judgment point by +k intervals, and the vector that connects the sequential data at the judgment point and sequential data that is separated from the judgment point by −k intervals.

When the value i+k is equal to or less than the number of sequential data that is the object of processing (step S603: NO), there is still data for which the discrete curvature can be found, so the accumulated data summary unit 005 calculates the discrete curvature of the (i+k)th object data that is counted in order from the oldest in terms of time (step S604). The accumulated data summary unit 005 then adds 1 to the value of variable i (step S605), and returns to step S603.

In step S603, when the value of i+k is greater than the number of object sequential data (step S603: YES), there is no sequential data for which the discrete curvature can be found, so next, the accumulated data summary unit 005 extracts the points from among the values of the discrete curvature that were calculated in step S604 that are local maximums as angular points (step S606). Then, the accumulated data summary unit 005 uses the method of least squares on the sequential data that is included in the range between angular points, and creates a collective approximation function (step S607). The data of the object sequential data that is the oldest in terms of time and that is the newest in terms of time are technically not angular points; however, they are taken to be angular points when executing processing. In other words, in step S607, the data for which approximation is executed first using the function is the sequential data that is included in the range between the oldest data in terms of time from among the object sequential data and the angular point that was extracted first, and the data for which approximation using the function is executed last is the data that is included in the range between the angular point that was extracted last and the newest data in terms of time from among the object sequential data.

In step S603, when not even one discrete curvature is created and processing advances to step S606, no angular points are extracted in step S606, however the oldest and newest data in terms of time of the object sequential data are regarded as being angular points, so it is possible to perform the processing of step S607 on.

The sequential data memory management unit 006 deletes the object sequential data that was inputted to the accumulated data summary unit 005 from the sequence data memory unit 002 (step S608). Next, the accumulated data summary unit 005 outputs the function parameter that was created in step S607 to the summary result evaluation unit 007 (step S609) and ends processing. In FIG. 20, step S608 and step S609 are illustrated as being executed sequentially; however, these steps are actually executed in parallel.

As was explained above, with this first embodiment, the sequence summary unit 003 evaluates data that is sequentially generated such as log data that is outputted from a server, or data that is outputted from a sensor, every time the data is generated. Then, based on the evaluation results, the sequence summary unit 003 performs processing to summarize the data while switching the function used for approximation. In doing so, it becomes possible to sequentially summarize data, and by eliminating time lag of starting analysis processing by the analysis unit 009, it is possible to perform analysis in real-time.

After a certain amount of sequentially generated data, such as log data that is outputted by a server, or data that is outputted from a sensor, has been accumulated, the accumulated data summary unit 005 performs summary processing by approximating the accumulated sequential data using a function. In doing so, it is possible to perform summarization with a higher summary precision or summary rate than sequential summarization. By evaluating the summary results from the sequence summary unit 003 and the summary results from the accumulated data summary unit 005 and selected the summary results having the highest evaluation value, it is possible to improve the summary precision or summary rate while maintaining the real-time capability.

### Embodiment 2

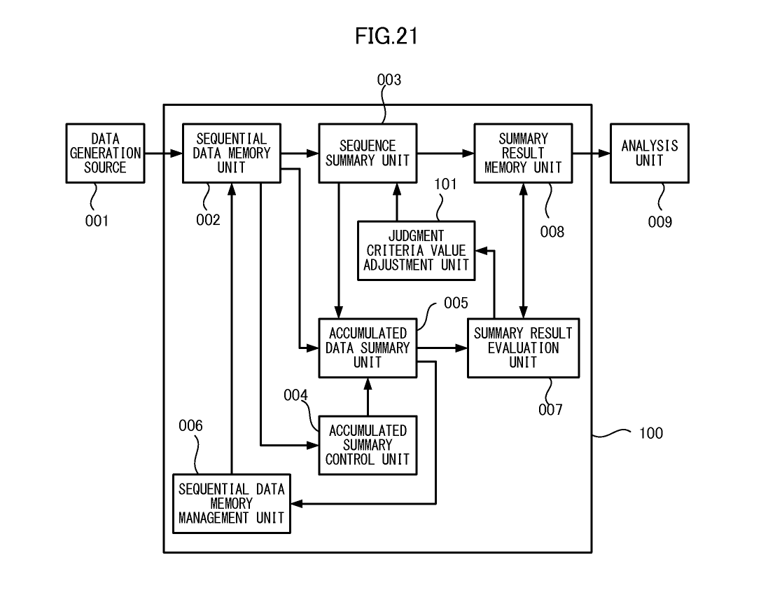

FIG. 21 is a block diagram illustrated an example of the construction of a data summary system 100 of a second embodiment. The data summary system 100 of this second embodiment adjusts the judgment criteria values of the sequence approximation function using the results of accumulated data summarization. The data summary system 100 of this second embodiment comprises a judgment criteria value adjustment unit 101 in addition to the component elements of the first embodiment in FIG. 1. The other construction is the same as that of the first embodiment.

When the sequence summary unit 003 approximates sequential data using a function, if the values of the two kinds of judgment criteria values (function correction threshold value T1 and function change threshold value T2), which are used for determining whether to perform processing to enlarge the domain of the sequence approximation function that was created when the previous one sequential data was inputted, or to perform processing to correct the domain and function parameter, or to divide the domain and create a new domain and function parameter, are not properly set, there is a possibility that the summary precision or summary rate will not be improved by the sequence summary unit 003. However, the type of data that is generated from the data generation source 001 and the frequency at which data is generated varies, and as a result, it is difficult to properly set the value beforehand, or for the user to properly set the values. Moreover, for the user to adequately adjust the parameter values becomes a burden for the user.

On the other hand, the accumulated data summary unit 005 performs approximation processing of a certain amount of accumulated data using a function, so that often it is possible to perform approximation (create a collective approximation function) with higher summary precision and at a higher summary rate than in the case of summarization by the sequence summary unit 003. Therefore, by feeding back the summary results of data summarized by the accumulated data summary unit 005, it becomes possible to automatically adjust the function correction threshold value T1 and the function change threshold value T2 that are internally held by the sequence summary unit 003 such that the summary precision or summary rate of the sequence approximation function become higher. As a result, it is possible to improve the summary performance (summary precision or summary rate) of the sequence summary unit 003, as well as it is possible to reduce the burden of adjusting the judgment criteria values.

As described above, in this second embodiment, by feeding back summary results from the accumulated data summary unit 005 for the function correction threshold value T1 and function change threshold value T2 that are internally held by the sequence summary unit 003, the function correction threshold value T1 and function change threshold value T2 that are internally held by the sequence summary unit 003 are adjusted. The method for adjusting the judgment criteria values will be explained in more detail later.

In the following, a description of parts that have the same construction as or perform the same processing as in the first embodiment will be omitted, and the following explanation will center mainly on the parts that are different from those of the first embodiment.

As in the first embodiment, the summary result evaluation unit 007 evaluates the collective approximation function that is outputted from the accumulated data summary unit 005 and the sequence approximation function that is read from the summary result memory unit 008 from the aspect of summary precision or summary rate. In the case where from the evaluation results it is determined that the collective approximation function has a higher evaluation value than the sequence approximation function, the summary result evaluation unit 007 deletes the function parameter stored in the summary result memory unit 008 of the sequence approximation function having a domain that is included in the domain of the collective approximation function, and instead stores the function parameter of the collective approximation function that was outputted from the accumulated data summary unit 005 in the summary result memory unit 008. At the same time, in this second embodiment, the summary result evaluation unit 007 outputs the function parameter of the collective approximation function and the sequential data that is the object of that collective approximation function to the judgment criteria value adjustment unit 101.

The judgment criteria value adjustment unit 101 adjusts the function correction threshold value T1 and function change threshold value T2 that are internally held in the sequence summary unit 003 based on function parameter of the collective approximation function and the sequential data that are the object of that collective approximation function that were inputted from the summary result evaluation unit 007.

The function correction threshold value T1 and the function change threshold value T2 can be adjusted so that the summary results from the sequence summary unit 003 become the same as the summary results from the accumulated data summary unit 005. In other words, the function correction threshold value T1 and function change threshold value T2 are adjusted while reproducing the processing by the sequence summary unit 003 using the sequential data that are the object of processing by the accumulated data summary unit 005 so that the dividing points of the domain of the sequence approximation function coincide with the dividing points of the domain of the collective approximation function.

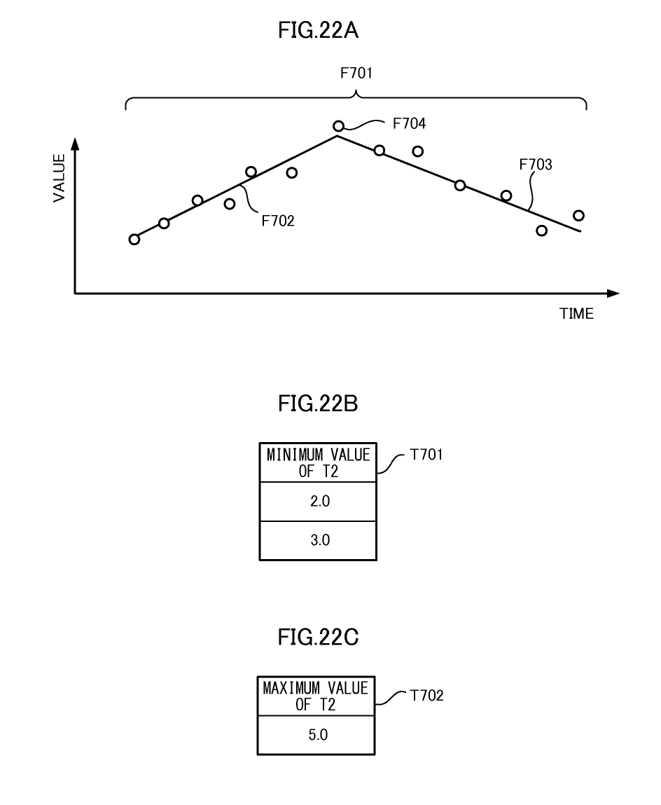

FIG. 22A to FIG. 22C are explanative drawings that illustrate an example of the judgment criteria value adjustment unit 101 adjusting the function correction threshold value T1 and function change threshold value T2. FIG. 22A is a drawing that illustrates a collective approximation function that was created from sequential data. FIG. 22B is a drawing that illustrates the minimum value of the function change threshold value T2 in FIG. 22A. FIG. 22C is a drawing that illustrates the maximum value of the function change threshold value T2 in FIG. 22A. In FIG. 22A, the group of points F701 is original data that were inputted from the summary result evaluation unit 007 and are the object of processing by the accumulated data summary unit 005. The straight line F702 and straight line F703 is the collective approximation function that was outputted from the accumulated data summary unit 005. The point F704 is sequential data at which switching of the function was performed (the point at which the domain of the collective approximation function was divided).

The judgment criteria value adjustment unit 101 first calculates a straight line (approximation function) that connects the oldest two points in terms of time of the group of points (F701) (two points on the left end). Next, the judgment criteria value adjustment unit 101 calculates the distance between the calculated straight line and the value (actual value) of the sequential data at the third point counted in the order of being the oldest in time (third point from the left end), and stores that distance in memory. The distance referred to here is the same as the distance explained in FIG. 15, and corresponds to the length of the line segment when a straight line is drawn along the vertical axis with respect to a straight line from the point of the sequential data. Next, using the least-squares method, the judgment criteria value adjustment unit 101 creates a new straight line that approximates the sequential data of the three points. Then the judgment criteria value adjustment unit 101 calculates the distance between the newly created straight line and the fourth point counted in order of oldest in time (fourth point from the left end). When the distance that is calculated here is greater than the distance stored in memory (distance between the straight line created first and the third point), the judgment criteria value adjustment unit 101 deletes the value of the distance stored in memory and stores the newly calculated distance. Next, using the least-squares method, the judgment criteria value adjustment unit 101 creates a new straight line. After that, the judgment criteria value adjustment unit 101 repeats this operation up to the dividing point of the domain of the collective approximation function indicated by point F704.

After the processing above has been repeated up to the point F704, the value of the distance (difference between the actual value and the approximation function) that is stored in memory last is the minimum value of the function change threshold value T2 for creating the straight line F702. In other words, by setting a value that is larger than the distance above for the function change threshold value T2, operation is performed so that the sequence summary unit 003 approximates the points between the oldest point (point on the left end) and the point F704 using the straight line F702. That is, the domain (sequence domain) is not divided up to point 704. The first record in the table T701 in FIG. 22B indicates that the value of the distance above is stored (a value of 2.0 in the example in FIG. 22B).

Next, after the above processing has been repeated up to point F704, the judgment criteria value adjustment unit 101 calculates the distance between the straight line that was calculated last and the one new point in terms of time from point F704 (the point on the right next to point F704), and stores the distance in memory. The value of this distance is the maximum value of the function change threshold value T2 for switching the straight line at point F704. In other words, when a value that is less than the value of the distance above is set for the function change threshold value T2, the sequence summary unit 003 performs an operation to switch (divide the domain) the straight line used for approximation at the point F704. The first record in table T702 in FIG. 22C indicates that the value of the distance that will be the maximum value of the function change threshold value T2 is stored (a value of 5.0 in the example in FIG. 22C).

Next, the judgment criteria value adjustment unit 101 calculates a straight line that connects the point F704 and one point newer in terms of time than point F704 (point on the right next to point F704). In other words, taking point F704 to be the oldest point in time (the point on the extreme left), and after that performing the same processing as the processing that was performed for the data included in the domain of the straight line F702, the maximum value of the distance is calculated. The second record in the table T701 in FIG. 22B is the maximum value of the distance between the actual value and the value of the approximation function that was calculated point F704 to the next dividing point of the collective domain (a value of 3.0 in the example in FIG. 22B).

In the example illustrated in FIG. 22A to FIG. 22C, there are two straight lines; however, the same operation is also performed in the case of there being only one straight line, or in the case of there being three or more straight lines. The number of values given in table T701 is the same as the number of straight lines (number of divisions of the collective domain), and the number of values given in table T702 is the “number of straight lines−1”.

After the processing above has been completed for all of the points included in the group of points F701, the judgment criteria value adjustment unit 101 adjusts the value of function correction threshold value T1 and the function change threshold value T2 from the values recorded in the table T701 and table T702. More specifically, the judgment criteria value adjustment unit 101 extracts the maximum value from among the value recorded in table T701 (a value of 3.0 in the case of FIG. 22B). Next, the judgment criteria value adjustment unit 101 extracts the minimum value from among the values recorded in table T702 (a value of 5.0 in the case of FIG. 22C). The judgment criteria value adjustment unit 101 then sets a value for the function change threshold value T2 to a value between the value extracted from table T701 and the value extracted from table T702. Any value can be set as long as the value of the function change threshold value T2 is between the value extracted from table T701 and the value extracted from table T702, for example, the average value between the value extracted from table T701 and the value extracted from table T702 (a value of 4.0 in this case) can be set.

In the case where only one function is approximated by the accumulated data summary unit 005 (in the case of only one straight line in the example illustrated in FIG. 22A), the number of data in the table T701 in FIG. 22B is only one, and there is no data in the table T702 in FIG. 22C. In such a case, the value of the data in table T701 can be set as the value of the function change threshold value T2.

When the value extracted from the table T701 is a value greater than the value extracted from the table T702, it is not possible for the sequence summary unit 003 to obtain the same results as the summary results from the accumulated data summary unit 005, so that adjustment of the judgment criteria values is not performed.

The judgment criteria value adjustment unit 101 extracts the minimum value from among the values recorded in the table T701 (the value of 2.0 in the case of FIG. 22B). The value of the function correction threshold value T1 can be set to any value as long as it is a value that is less than the value (2.0) extracted from the table T701, for example, the value of the function correction threshold value T1 can be set to the value (2.0) that was extracted from the table T701. When the value of the function correction threshold value T1 is set to a value that is greater than the minimum value that is recorded in the table T701, there is a possibility that the parameter of the sequence approximation function will not be corrected even though the difference between the actual value and the calculated value is greater than the minimum value of the table T701, and there is a possibility that after that the domain will be divided at a point that is not the dividing point of the domain of the collective approximation function.

As described above, by the judgment criteria value adjustment unit 101 adjusting the values of the function correction threshold value T1 and the function change threshold value T2, it is possible for the sequence summary unit 003 to obtain the same results as the summary results from the accumulated data summary unit 005. The summary results from the accumulated data summary unit 005 are summary results having a high summary precision or high summary rate, so that by adjusting the function correction threshold value T1 and the function change threshold value T2 as described above, it is possible to improve the summary performance (summary precision or summary rate) of the sequence summary unit 003.

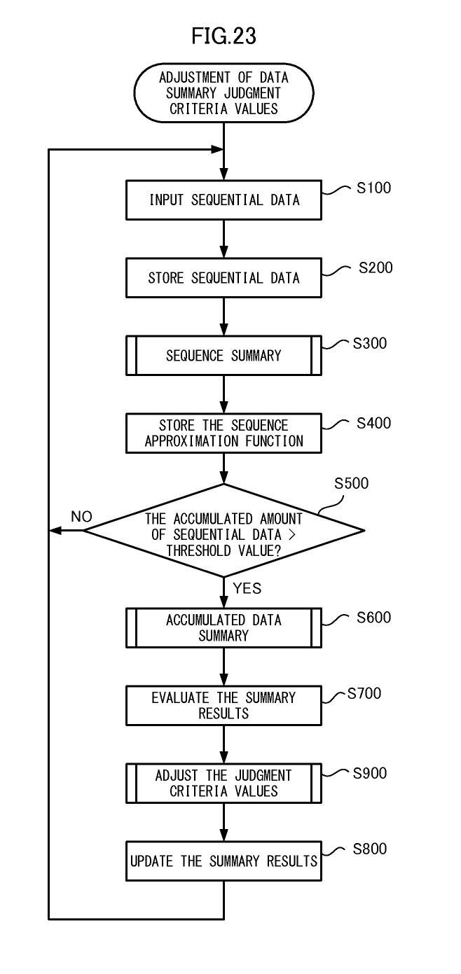

FIG. 23 is a flowchart illustrating an example of the operation of the data summary process of this second embodiment. In the operation of the data summary process of this second embodiment, there is a judgment criteria value adjustment step (step S900) after the summary result evaluation step (step S700). The other steps are the same as in the data summary process of the first embodiment illustrated in FIG. 18.

In FIG. 23, as in the flowchart of the first embodiment (FIG. 18), each step (steps S100 to S900) are illustrated as being sequential; however, actually, in the data summary system 100, the processing of each of the steps S100 to S900 is executed in parallel.

Of the steps illustrated in FIG. 23, step S100 to step S700 and step S800 are the same as in the first embodiment.

The summary result evaluation unit 007 evaluates the summary results (function parameters) from the sequence summary unit 003 and the accumulated data summary unit 005 according to an evaluation function that was created from the aspect of summary precision and summary rate (step S700). When the evaluation value of the collective approximation function that was inputted from the accumulated data summary unit 005 is a higher value, the summary result evaluation unit 007 outputs the function parameter of the collective approximation function to the summary result memory unit 008. The summary result evaluation unit 007 also outputs the function parameter of the collective approximation function and the sequential data that are the object of the collective approximation function to the judgment criteria value adjustment unit 101.

The judgment criteria value adjustment unit 101 adjusts the values of the function correction threshold value T1 and function change threshold value T2 that are held internally by the sequence summary unit 003 based on the function parameter of the collective approximation function that was inputted from the summary result evaluation unit 007 and the sequential data that is the object of that collective approximation function (step S900).

The summary result memory unit 008 deletes the parameter functions of sequence approximation functions that have a domain that is included in the same domain as the function parameter of the collective approximation function, and stores the function parameter of the inputted collective approximation function (step S800). In the order of processing, it does not matter whether the step of adjusting the judgment criteria values (step S900) or the step of updating the approximation function (step S800) is performed first.

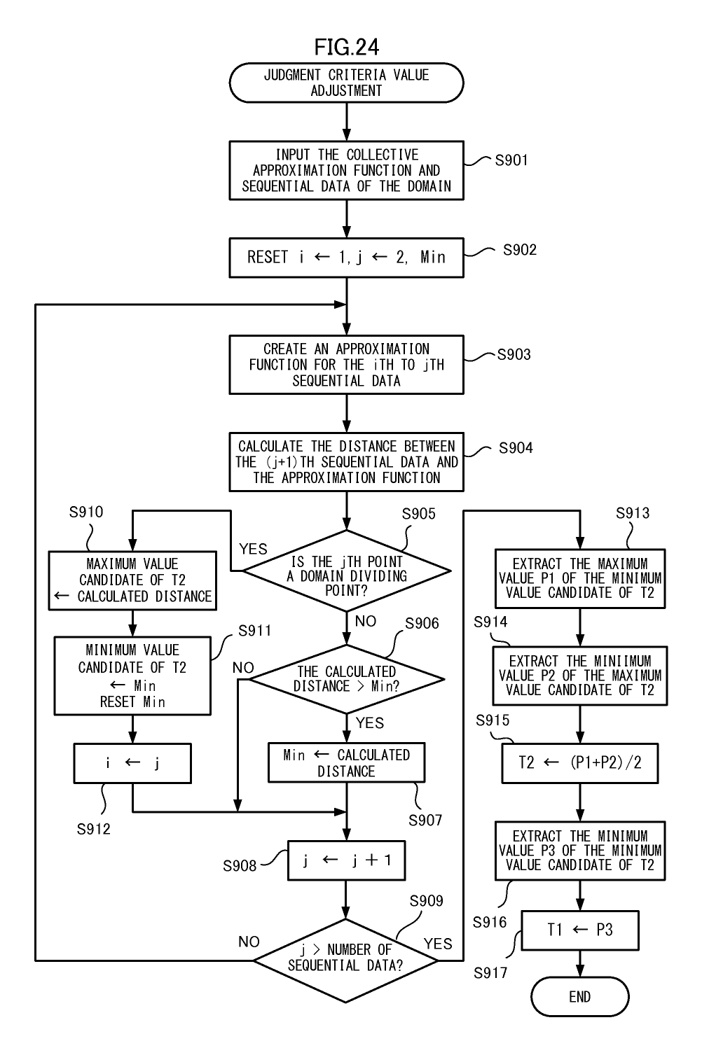

FIG. 24 is a flowchart that illustrates an example of the operation of the processing for adjusting the judgment criteria values of this second embodiment. The processing in FIG. 24 illustrates the contents of the step (step S900) for adjusting the judgment criteria values in FIG. 23. First, the judgment criteria value adjustment unit 101 inputs the function parameter of the collective approximation function that was outputted by the accumulated data summary unit 005 from the summary result evaluation unit 007 and the sequential data of the domain of that collective approximation function (step S901). Next, the judgment criteria value adjustment unit 101 substitutes 1 for variable i and 2 for variable j (step S902). The judgment criteria value adjustment unit 101 also substitutes (resets) a possible maximum value for the tentative minimum value Min of T2.

Using the method of least squares, the judgment criteria value adjustment unit 101 creates a straight line from the ith sequential data to the jth sequential data that is object data in order of being oldest in time (step S903). First, the judgment criteria value adjustment unit 101 creates a straight line that connects from the first to the second sequential data. Next, the judgment criteria value adjustment unit 101 calculates the distance between the straight line that was created in step S903 and the (j+1)th object sequential data counted in order of oldest in time (step S904). When the jth sequential data is the last sequential data in the domain, there is no (j+1)th sequential data, so that the distance is not calculated.

The judgment criteria value adjustment unit 101 determines whether or not the jth sequential data counted in order of oldest in time of the object data is a dividing point of the domain (collective domain) (step S905). Here, the last sequential data of the domain is taken to be a dividing point. In the case that the jth sequential data is not a dividing point, (step S905: NO), the judgment criteria value adjustment unit 101 compares the value of the distance calculated in step S904 with the value of the distance that is buffered as the tentative minimum Min of the function change threshold value T2 (step S906).

When the value of the distance calculated in step S904 is greater than the tentative minimum Min (step S906: YES), the judgment criteria value adjustment unit 101 updates the tentative minimum value Min of the function of the function change threshold value T2 to the value of the distance calculated in step S904 (step S907). When the distance is first calculated in step S904, the tentative minimum value Min of the function change threshold value T2 is initially set to the possible maximum value, so that step S906 is always ‘YES’, and the calculated distance is set for the tentative minimum value Min. When the distance calculated in step S904 is equal to or less than the tentative minimum value Min of the function change threshold value T2 (step S906: NO), the judgment criteria value adjustment unit 101 does not set the value of the currently calculated distance as the tentative minimum value Min. Processing then moves from step S906 to step S908.

On the other hand, in step S905, when the jth sequential data that is counted in order of oldest in time of the object sequential data is a dividing point of the domain (step S905: YES), the judgment criteria value adjustment unit 101 stores the value of the distance calculated in step S904 as a maximum value candidate for the function change threshold value T2 (step S910). When the jth sequential data is the last sequential data of the domain, the distance is not calculated so a maximum value candidate for the function change threshold value T2 is not stored. The number of maximum value candidates for the function change threshold value T2 that is stored is equal to the number of dividing points of the domain (except for the last point of the domain).

The judgment criteria value adjustment unit 101 stores the tentative minimum value Min that was buffered in step S907 as the minimum value candidate for the function change threshold value T2, and substitutes (resets) a possible maximum value for the tentative minimum value Min (step S911). The number of minimum value candidates for the function change threshold value T2 is equal to just the number of dividing points of the domain+1. Next, the judgment criteria value adjustment unit 101 substitutes the value of variable j for variable i (step S912).

In the case of NO in step S906, after step S907 or step S912, the judgment criteria value adjustment unit 101 adds 1 to the value of variable j (step S908) and determines whether or not the value of variable j is greater than the number of object sequential data (step S909). The number of object sequential data is the number of sequential data that were inputted from the summary result evaluation unit 007. When the value of variable j is equal to or less than the number of object data (step S909: NO), processing returns to step S903, and the judgment criteria value adjustment unit 101 creates an approximation function for the ith to the jth sequential data.

When the value of variable j is greater than the number of object data (step S909: YES), the judgment criteria value adjustment unit 101 extracts the maximum value P1 from among the minimum value candidates for T2 stored in step S911 (step S913). Next, the judgment criteria value adjustment unit 101 extracts the minimum value P2 from among the maximum value candidates for the function change threshold value T2 that was stored in step S910 (step S914). Then, the judgment criteria value adjustment unit 101 sets the average value of P1 and P2 as the value of the function change threshold value T2 (step S915). The judgment criteria value adjustment unit 101 extracts the minimum value P3 from among the minimum value candidates for the function change threshold value T2 that was stored in step S911 (step S916). The judgment criteria value adjustment unit 101 then sets the value of the minimum value P3 for the value of the function correction threshold value T1 (step S917), and ends processing.

As described above, with the data summary system 100 of this second embodiment, in addition to the effect of the first embodiment, by adding processing by the judgment criteria value adjustment unit 101 to adjust the function correction threshold value T1 and function change threshold value T2 that are internally held by the sequence summary unit 003, it is possible to automatically adjust the function correction threshold value T1 and function change threshold value T2 that are internally held by the sequence summary unit 003 so that the dividing points of the domain of the sequence approximation function becomes the same as the dividing points of the domain of the collective approximation function. As a result, it is possible to improve the summary performance (summary precision or summary rate) of the sequence summary unit 003, as well as it is possible to reduce the burden of adjusting the parameters.

### Embodiment 3

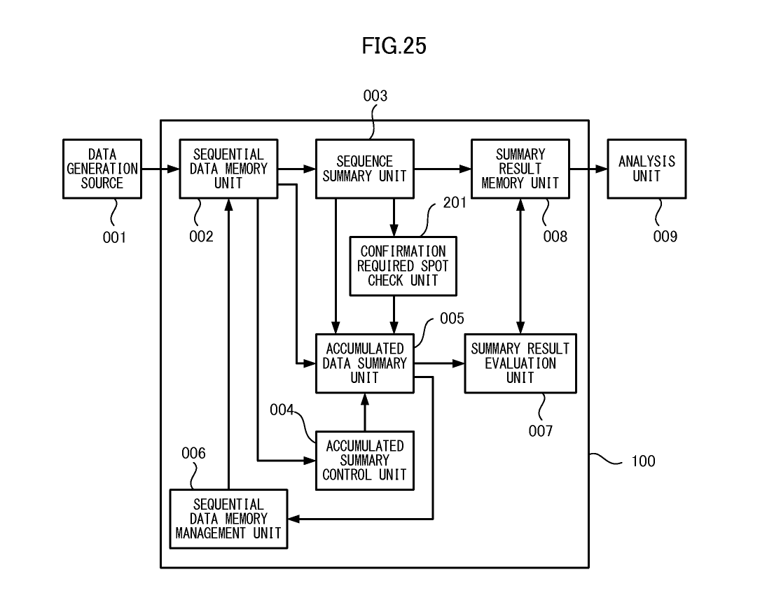

FIG. 25 is a block diagram that illustrates an example of construction of a data summary system 100 of a third embodiment. In this third embodiment, accumulated data summarization (creation of a collective approximation function) is performed only near sequential data that correspond to specified conditions detected during the sequence summary process. As illustrated in FIG. 25, the data sequence system 100 of this third embodiment comprises a confirmation required spot check unit 201 in addition to the components elements of the first embodiment illustrated in FIG. 1. The other construction is the same as in the first embodiment. The explanation below will center mainly on the parts that differ from the first embodiment.

In the data summary system 100 of the first embodiment, the accumulated data summary unit 005 summarizes all of the sequential data that is generated from the data generation source 001. However, the accumulated data summary unit 005 summarizing all of the sequential data that is generated from the data generation source 001 is inefficient. In a range where the collective approximation function has about the same summary precision and summary rate as the sequence approximation function, it can be said that creating a collective approximation function is not necessary.

In the case where the accumulated data summary unit 005 summarizes all of the continuously generated sequential data, when the amount of data that can be processed by the accumulated data summary unit 005 is less than the amount of data that is generated from the data generation source 001, there is a problem in that the amount of unprocessed sequential data gradually increases. Moreover, in the case where a large amount of data is generated from the data generation source 001, it is normally difficult to make the amount of data that can be processed by the accumulated data summary unit 005 greater than the amount of data generated by the data generation source 001.

Therefore, when the sequence summary unit 003 sequentially summarizes sequential data, the spots that required confirmation (confirmation required spot will be defined later) for creating a collective approximation function are checked, and sequential data can be efficiently summarized by having the accumulated data summary unit 005 summarize only data near the checked spots. Moreover, by having the accumulated data summary unit 005 summarize only the data near the checked spots, it is possible to prevent an increase of unprocessed sequential data.

The confirmation required spot check unit 201 in FIG. 25 comprises a function of checking (storing) confirmation required spots when the sequence summary unit 003 sequentially summarizes sequential data and notifying the accumulated data summary unit 005 or checked spots.

Confirmation required spots are spots for which the summary precision or summary rate can probably be improved by summarization by the accumulated data summary unit 005, and more specifically are spots where when the sequence summary unit 003 sequentially summarizes sequential data that is inputted from the data memory unit 002, the difference between the actual value and the calculated value (F105 in FIG. 6) is a value that is near the value of the function change threshold value T2 that is stored internally by the sequence summary unit 003. When the difference between the actual value and the calculated value is a value near the function change threshold value T2, that sequential data (actual value) is sequential data near a boundary where switching of the function occurs or does not occur, so that by having the accumulated data summary unit 005 summarize sequential data that is included in the range near that sequential data, it is probable that the summary precision or summary rate will be improved.

More specifically, every time the sequence summary unit 003 sequentially summarizes sequential data that is inputted from the sequential data memory unit 002, the confirmation requested spot check unit 201 inputs the approximation difference, which is (the absolute value of) the difference between the actual value and calculated value, the value of the function change threshold value T2, and information (for example, time) that includes the order of sequential data from the sequence summary unit 003. When the absolute value of the difference between the approximation difference and the value of the function change threshold value T2 is less than a threshold value that is internally stored in the confirmation requested spot check unit 201, the confirmation requested spot check unit 201 stores information (for example, time) that includes the order of that sequential data as the confirmation requested spot. When there is a request from the accumulated data summary unit 005, the confirmation requested spot check unit 201 outputs the stored information (for example, time) that includes the order of the sequential data to the accumulated data summary unit 005.

Only when the approximation difference, which is (the absolute value of) the difference between the actual value and the calculated value exceeds the value of the function change threshold value T2, that difference can be checked as a confirmation requested spot when that difference is less than the threshold value. In other words, a spot is checked as a confirmation requested spot only when the domain of the sequence approximation function is divided. When the approximation difference is equal to or less than the function change threshold value T2, the domain is not divided, so that it is not necessary to create a new collective approximation function.

By storing the value of the function change threshold value T2 that was inputted from the sequence summary unit 003 the first time in the confirmation requested spot check unit 201, there is no need to store the value from the second time and later. The threshold value that the confirmation requested spot check unit 201 stores internally for checking (storing) confirmation requested spots can be a value that is set in advance, or can be a value that is arbitrarily set by the user.

In this third embodiment, the accumulated data summary unit 005 receives an instruction from the accumulated summary control unit 004 to perform operation, after which the confirmation requested spot is input from the confirmation requested spot check unit 201, sequential data in the range near the confirmation requested spot is inputted from the sequence data memory unit 002, and then the accumulated data summary unit 005 executes summary processing. The accumulated data summary unit 005 internally stores a parameter for setting how large of a range of sequential data centered around the confirmation required spot is to be the object of processing. The parameter that sets the range for creating a collective approximation function can be a value that is set in advance, or can be arbitrarily set by the user. Moreover, when not even one confirmation requested spot is stored in the confirmation requested spot check unit 201, the accumulated data summary unit 005 does not execute summary processing.

In this embodiment, after the accumulated data summary unit 005 executes summary processing, the sequential data memory unit 006, deletes not only sequential data that is the object of processing by the accumulated data summary unit 005 from the sequential data memory unit 002, but also sequential data that is older in time than the sequential data that is the object of processing by the accumulated data summary unit 005.

In this third embodiment, the accumulated data summary unit 005 executes the accumulated data summary process for just sequential data in a specified range that includes a confirmation requested spot, so that there may be cases in which the domain of the collective approximation function does not match the domain of the sequence approximation function. In such a case, the summary result evaluation unit 007 reads from the summary result memory unit 008 the function parameters of the sequence approximation functions in a range of domains that includes the domain of the collective approximation function that is inputted from the accumulated data summary unit 005.

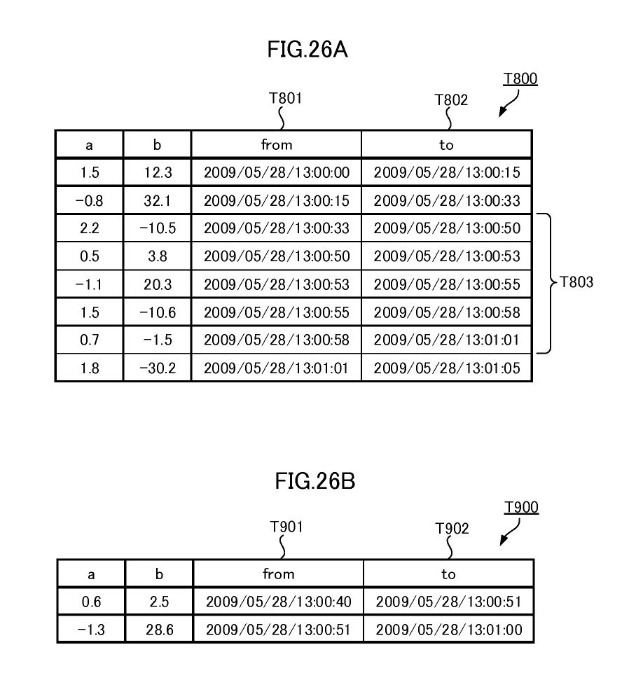

FIG. 26A and FIG. 26B illustrate an example of a case in this third embodiment in which there is no domain of a sequence approximation function that coincides with the domain of the collective approximation function. FIG. 26A illustrates function parameters of sequence approximation functions stored in the summary result memory unit 008. FIG. 26B illustrates function parameters of collective approximation functions that were inputted from the accumulated data summary unit 005.

In FIGS. 26A and 26B, the accumulated result evaluation unit 007 searches the starting points (from) T901 of the domains of the function parameters T900 of the collective approximation function for values that are newer in time than that the oldest value in time (in the example illustrated in FIG. 26B “2009/05/28/13:00:40”) from among the ending points (to) T802 of the domains of the function parameters T800 of the sequence approximation functions. The accumulated result evaluation unit 007 searches for the newest values in time in order from the top of the list of the function parameters T800, and stores the position of the first record found that is a new value in time (in the example illustrated in FIG. 26A, the third record from the top).

Next, of the ending points (to) T902 of the domains of the function parameters T900, the accumulated result evaluation unit 007 searches for a newer value in time than the newest value in time (in the example illustrated in FIG. 26B, “2009/05/28/13:01:00”) from among the ending points (to) T802 of the domains of the function parameters T800. The accumulated result evaluation unit 007 searches for new values in time in order from the top of the list of function parameters T800, and stores the position of the first record found having a new value in time, and stores that position in memory (in the example illustrated in FIG. 26A, the 7th record from the top). The function parameters between the positions of the two records above are function parameters that are read from the summary result memory unit 008. In the example in FIG. 26A, the function parameters for records T803 are read. The domains of the function parameters of the sequence approximation functions that are read from the summary result memory unit 008 include the domain of the function parameter of the collective approximation function that is inputted from the accumulated data summary unit 005.

After reading the function parameters of the sequence approximation function of the domains that include the domain of the collective approximation function, the summary result evaluation unit 007 evaluates the function parameter of the collective function and the function parameters of the sequence approximation functions that were read from the summary result memory unit 008 using an evaluation function in the same way as in the first embodiment. When the evaluation value of the collective approximation function that was inputted from the accumulated data summary unit 005 is greater than the evaluation values of the sequence approximation function that were read from the summary result memory unit 008, the summary result evaluation unit 007 deletes the portion of the function parameters of the sequence approximation functions that are stored in the summary result memory unit 008 that correspond to the domain of the collective approximation function, and newly stores the function parameter of the collective approximation function that was inputted from the accumulated data summary unit 005. However, when the domain of the function parameters that were read from the summary result memory unit 008 is greater than the domain of the function parameter that was outputted from the accumulated data summary unit 005, missing data may occur when deleting the range that includes the domain of the collective approximation function. Therefore, the portions having missing data due to deleting the function parameters of the sequence approximation functions, are compensated for by using function parameters of the sequence approximation functions that were originally stored in the summary result memory unit 008.

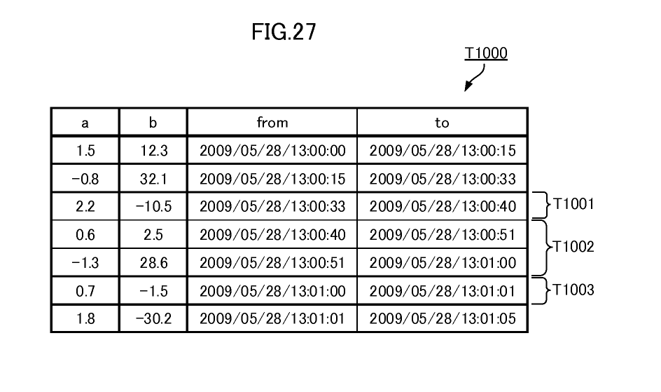

FIG. 27 illustrates an example of compensating for the portion having missing data due to deleting the function parameters of the sequence approximation functions. In the example of FIG. 26A and FIG. 26B, when from the evaluation results by the summary result evaluation unit 007, the evaluation value of the function parameters T900 that were inputted from the accumulated data summary unit 005 is greater than the evaluation value of the records T803 of the function parameters T800 that were read from the summary result memory unit 008, all of the records T803 are deleted, and the function parameters T900 are newly stored instead, so that the data from “2009/05/28/13:00:33” to “2009/05/28/13:00:40”, and the data from “2009/05/28/13:01:00” to “2009/05/28/13:01:01” are missing. Therefore, the data from “2009/05/28/13:00:33” to “2009/05/28/13:00:40”, and the data from “2009/05/28/13:01:00” to “2009/05/28/13:01:01” are compensated for by using the function parameters that were originally stored in the summary result memory unit 008.

More specifically, a list (T1000) of function parameters as illustrated in FIG. 27 is obtained. Of the function parameters T1000 illustrated in FIG. 27, the records illustrated on line T1001 and line T1003 are the result of compensating the data from “2009/05/28/13:00:33” to “2009/05/28/13:00:40”, and the data from “2009/05/28/13:01:00” to “2009/05/28/13:01:01” using the function parameters that were originally stored in the summary result memory unit 008. In line T1001, the value of the ending point (to) T802 of the third record of the function parameters T800 in FIG. 26A (first record of records T803) is changed to the value of the starting point (from) T901 of the first record of the list of function parameter T900 in FIG. 26B, and in line T1003, the value of the starting point (from) T801 of the seventh record (last record of the records T803) of the function parameters T800 in FIG. 26A is changed to the value of the ending point (to) T902 of the last record of the function parameter T900 in FIG. 26B. Moreover, T1002 is the same as the function parameters T900 in FIG. 26B.

As described above, by making only the sequential data in a specified range that includes the confirmation required spot that is checked by the confirmation required spot check unit 201 to be the object of processing by the accumulated data summary unit 005, data summarization can be performed efficiently. Furthermore, by having the accumulated data summary unit 005 perform summary processing for only sequential data in a specified range that includes the confirmation required spot, it is possible to prevent an increase of unprocessed data.

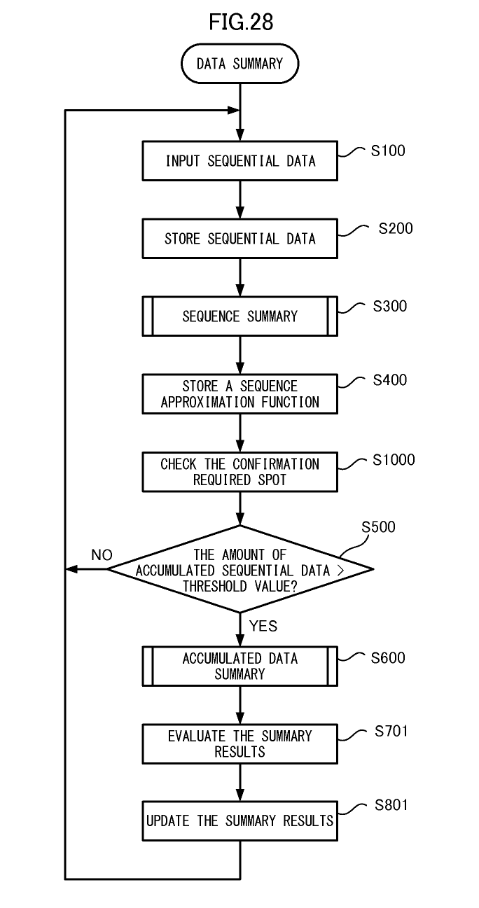

FIG. 28 is a flowchart illustrating an example of the data summary processing of this third embodiment. The operation of the data summary process of this third embodiment comprises a step (step S1000) of checking the confirmation required spots after the step of storing sequence approximation functions (step S400). Of the steps illustrated in FIG. 28, the operation of the steps S100, S200, S300, S400 and S500 is the same as in the first embodiment.

As in the flowchart for the first embodiment (FIG. 18), in FIG. 28 as well, each of the steps (step S100 to S1000) are illustrated as being sequentially executed; however, actually, the data summary system 100 executes the processing of the steps S100 to S1000 in parallel.

After the sequence summary unit 003 sequentially summarizes the sequential data that are inputted from the sequential data memory unit 002 (step S300), the confirmation required spot check unit 201 inputs the difference between the actual values and calculated values at that time, the value of the function change threshold value T2, and the times at which the data ere inputted are inputted from the sequence summary unit 003. When the difference between the difference between the actual value and the calculated value, and the value of the function change threshold value T2 becomes less than a threshold value that is internally stored in the confirmation required spot check unit 201, the confirmation requested spot check unit 201 stores the time, which is information (for example, time) that includes the order of that sequential data as the confirmation requested spot (step S1000).

Of the accumulated data summary (step S600) the operation that differs from that of the first embodiment is the step (step S608) in the flowchart illustrated in FIG. 20 of deleting data that is stored in the sequential data memory unit 002. In this embodiment, that data that are deleted in this step are the data stored in the sequential data memory unit 002 that are older in time than the data that are the object of processing by the accumulated data summary unit 005.

In the summary result evaluation step (step S701), the sequence approximation function and collective approximation function of the interval for which the collective approximation was created are evaluated according to an evaluation function. When the evaluation value of the collective approximation function that was inputted from the accumulated data summary unit 005 is a higher value, the summary result evaluation unit 007 outputs the function parameter of the collective approximation function to the summary result memory unit 008.

After the function parameter of a collective approximation function that was created by the accumulated data summary unit 005 has been input to the summary result memory unit 008 from the summary result evaluation unit 007, the summary result memory unit 008 deletes the function parameters of the sequence approximation functions that have a domain that is included in the same domain as the function parameter of the inputted collective approximation function, and stores the function parameter of the inputted collective approximation function (step S801). In a step of updating summary results (step S801), when the summary result (function parameter of the collective approximation function) by the accumulated data summary unit 005 is inputted from the summary result evaluation unit 007, the summary result evaluation unit 007 deletes the function parameters that are stored in the summary result memory unit 008 of the domains that include the function parameter that is inputted from the summary result evaluation unit 007, and stores the function parameter that was inputted from the summary result evaluation unit 007. In the case where there is missing data in the summary result memory unit 008 after the function parameters of the sequence approximation functions have been updated to the function parameter of the collective approximation function, the summary result evaluation unit 007 executes processing to compensate for the portion with missing day with the function parameters of the original sequence approximation functions.

As described above, with the data summary system 100 of this third embodiment, by comprising a function of a confirmation required spot check unit 201 checking (storing) a confirmation required spot, and then notifying the accumulated data summary unit 005 of the checked spot, it is possible to efficiently perform the summary process by the accumulated data summary unit 005 in addition to the effects of the first embodiment. Moreover, by the accumulated data summary unit 005 summarizing only sequential data in a specified range that includes the confirmation required spot, it is possible to prevent an increase of unprocessed sequential data.

### Embodiment 4

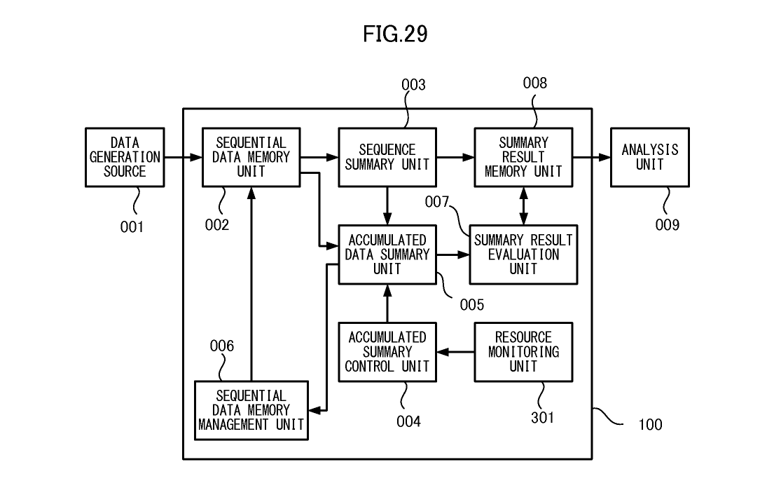

FIG. 29 is a block diagram that illustrates an example of the construction of a data summary system 100 of a fourth embodiment. In this fourth embodiment, accumulated data summarization is performed when the status of resources of a computer that operates the data summary system 100 conforms to certain specified conditions. As illustrated in FIG. 29, in addition to the component element of the first embodiment illustrated in FIG. 1, the data summary system 100 of this fourth embodiment comprises a resource monitoring unit 301.

In the data summary system 100 of the first embodiment, the accumulated summary control unit 004 monitors the amount of sequential data that is accumulated in the sequential data memory unit 002, and when a certain fixed amount of sequential data has been accumulated, outputs an instruction to the accumulated data summary unit 005 to operate. However, when a large amount of sequential data is generated, the speed that sequential data is accumulated in the sequential data memory unit 002 becomes fasters, so that the accumulated summary control unit 004 operates at a higher frequency, and in a condition where a large amount of sequential data is generated, the sequence summary unit 003 also operates frequently, so the load on the computer that operates the data summary system 100 becomes high. Under such conditions, when the accumulated data summary unit 005 also operates frequently, the load on the computer that operates the data summary system 100 becomes even higher, and there is a possibility that the overall performance will drop.

Therefore, the resource monitoring unit 301 monitors the status of the resources (CPU, memory and the like) of the computer that the data summary system 100 operates, and when the availability status of the resources becomes greater than a certain value, causes the accumulated data summary unit 005 to operate. As a result, it is possible to reduce the load on the computer that the data summary system 100 operates, and prevent the performance of the overall system from dropping.

As described above, in this embodiment, the resource monitoring unit 301 monitors the availability status of the resources, and when the availability status of the resources exceeds a certain value, the accumulated summary control unit 004 instructs the accumulated data summary unit 005 to operate. This method will be explained in more detail later. The explanation below will mainly center on the parts that differ from the first embodiment.

The resource monitoring unit 301 comprises a function for monitoring the status of resource usage such as the rate of usage of the CPU, and the rate of usage of the memory of the computer that the data summary system 100 operates.

In this fourth embodiment, the accumulated summary control unit 004 does not monitor the amount of data that is stored in the sequential data memory unit 002, but references the status of usage of resources such as the rate of usage of the CPU or rate of usage of the memory that are monitored by the resource monitoring unit 301. The accumulated summary control unit 004, for example, can be such that it operates when the rate of usage of the CPU of the computer that the data summary system 100 operates is 20% or less, or for example, can be such that it operates when the rate of usage of the CPU of the computer that the data summary system 100 operates is 30% or less, and the rate of usage of the memory is 25% or less. The condition of the status of usage of the resources necessary in order for the accumulated summary control unit 004 to output an instruction to the accumulated data summary unit 005 can be registered in advance, or can be arbitrarily set by the user.

As described above, the resource monitoring unit 301 monitors the rate of usage of the CPU or the rate of usage of memory of the computer that the data summary system 100 operates, and when the availability status of the resources is equal to or greater than a certain value, the accumulated summary control unit 004 operates, so it is possible to reduce the load on the computer that the data summary system 100 operates, and prevent the performance of the overall system from dropping.

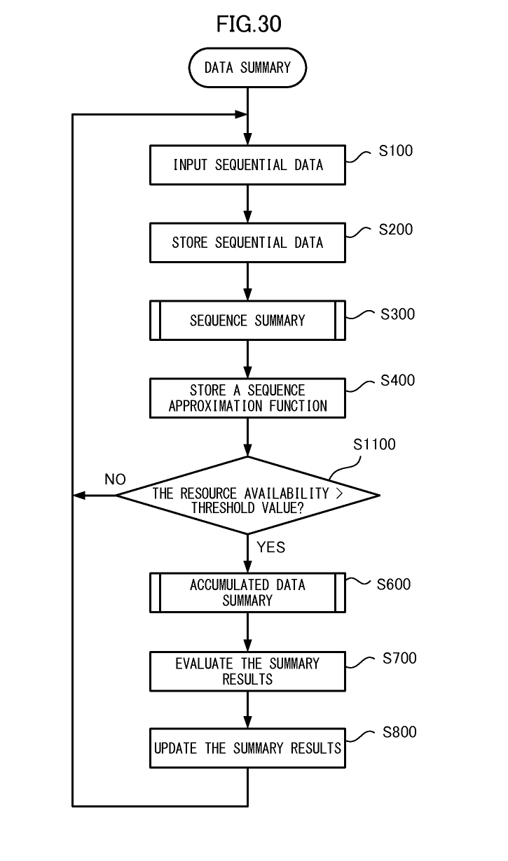

FIG. 30 is a flowchart that illustrates an example of the data summary processing of this fourth embodiment. As illustrated in FIG. 30, in this fourth embodiment, whether or not to perform accumulated data summarization (corresponds to step S500 in FIG. 18) is determined by the availability status of the resources (step S1100). As in the flowchart for the first embodiment (refer to FIG. 18), in FIG. 30 as well, the steps (step S100 to S1100) are illustrated as being executed in sequence; however, actually, the data summary system 100 executes the processing of the steps S100 to S1100 in parallel.

In the flowchart of this fourth embodiment (FIG. 30), the step (step S500) of determining whether the amount of sequential data that is stored in the sequential data memory unit 002 is equal to or greater than a certain value is replaced by a step (step S1100) of determining whether the availability status of resources such as the CPU or memory of the computer that is operated by the data summary system 100 is equal to or greater than a certain value, and the operation of the other steps (step S100 to step S400 and step S600 to step S800) is the same as in the first embodiment.

As described above, with this fourth embodiment, in addition to the effect of the first embodiment, the resource monitoring unit 301 monitors the status of usage of resources, such as the CPU or memory of the computer that is operated by the data summary system 100, and when the availability status of the resource is equal to or greater than a certain value, the accumulated summary control unit 004 operates, so that it is possible to reduce the load on the computer that is operated by the data summary system 100, and prevent a drop in performance of the overall system.

By combining this embodiment with the first embodiment in which accumulated data summary processing is started according to the amount of sequential data that is stored in the sequential data memory unit 002, it is possible to perform accumulated data summary processing when the amount of accumulated sequential data (data for which accumulated data summary processing has not been performed) is a certain value or greater and the availability status of resources is a certain value or greater.

### Embodiment 5

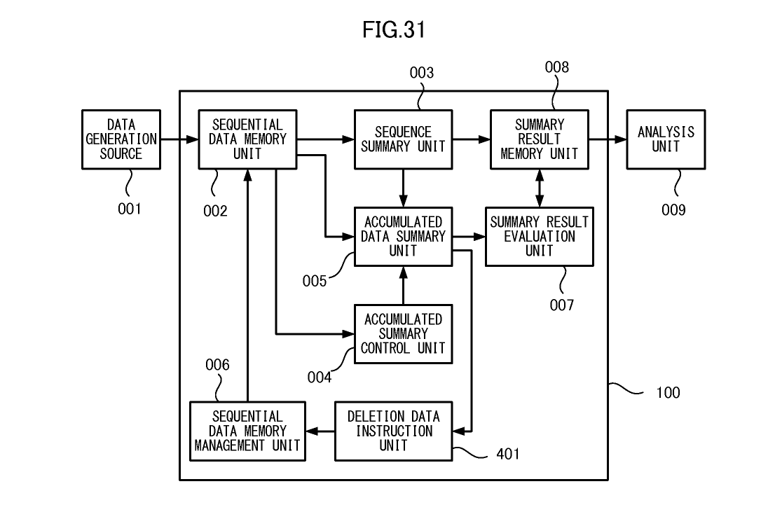

FIG. 31 is a block diagram that illustrates an example of the construction of a data summary system 100 of a fifth embodiment. In this fifth embodiment, the range of sequential data that is the object of accumulated data summarization is different than in the first embodiment. As illustrated in FIG. 31, the data summary system 100 of this fifth embodiment comprises a deletion data instruction unit 401.

In the data summary system 100 of the first embodiment, of the sequential data that is stored in the sequential data memory unit 002, the data that the sequential data memory management unit 006 takes to be the object of processing by the accumulated data summary unit 005 is sequential data in a range where the domain of the sequence approximation function that was created by the sequence summary unit 003 is set. In other words, the object sequential data is sequential data that, except for sequential data that is included in a domain for which there is a possibility of expansion by the sequence summary unit 003 performing sequence summary processing, is stored in the sequential data memory unit 002 (data for which a collective approximation function has not been created) by the sequence summary unit 003 performing sequence summary processing. All of the sequential data for which a collective approximation function has been created is deleted.

However, when sequential data is deleted in this way, the sequential data that becomes the next object of processing by the accumulated data summary unit 005 always comprises sequential data at the point where the sequence summary unit 003 switched functions (dividing point of the sequence domain). Therefore, the summary results of the accumulated data summary unit 005 depend on the summary results of the sequence summary unit 003, and there is a possibility that they could be the cause of no rise in the summary precision or summary rate.

Therefore, the deletion data instruction unit 401 does not delete all of the sequential data that is stored in the sequential data memory unit 002 and that is the object of processing by the accumulated data summary unit 005, but leaves part of the sequential data so that the accumulated data summary unit 005 can execute summary processing on data near the point where switching of functions is performed. In order for that, the deletion data instruction unit 401 instructs the sequential data memory management unit 006 on which sequential data to delete. By doing so, it is possible to prevent the summary results of the accumulated data summary unit 005 from being too dependent on the summary results of the sequence summary unit 003, and it is possible to increase the summary precision or summary rate.

As described above, in this fifth embodiment, the deletion data instruction unit 401 instructs the sequential data memory management unit 006 on which of the data stored in the sequential data memory unit 002 to delete. The sequential data memory management unit 006 deletes the data for which there was a deletion instruction from the sequential data memory unit 002. The method for this will be described in detail later. The explanation below will mainly center on the parts that are different from the first embodiment.

In this fifth embodiment, the accumulated data summary unit 005 executes summary processing of the data stored in the sequential data memory unit 002, then of the data that was the object of processing, outputs the sequential data that is the newest in time (information that includes the order, such as time) to the deletion data instruction unit 401.

The deletion data instruction unit 401 has a function of instructing the sequential data memory management unit 006 on which sequential data is to be deleted. More specifically, the deletion data instruction unit 401 instructs the sequential data memory management unit 006 to delete data that are from a specified amount of time (specified interval) before the time sequential data is inputted from the accumulated data summary unit 005. As a result, without deleting all of the data that is the object of processing by the accumulated data summary unit 005, it is possible to leave data near the point where the sequence summary unit 003 switches functions. A parameter used by the deletion data instruction unit 401 to determine how much data to leave without deleting can be set beforehand, or can be arbitrarily set by the user.

In this fifth embodiment, the sequential data memory management unit 006 deletes data that is stored in the sequential data memory unit 002 based on an instruction that is inputted from the deletion data instruction unit 401.

In this fifth embodiment, when the summary result evaluation unit 007 reads a function parameter of a sequence approximation function from the summary result memory unit 008, there is a possibility that there will not be a function parameter whose domain coincides with that of a collective approximation function that is outputted from the accumulated data summary unit 005. In such a case, as in the third embodiment, the summary result evaluation unit 007 reads the function parameters of the sequence functions having a domain that includes the domain of the collective approximation function from the summary result memory unit 008. Moreover, in this fifth embodiment, as in the third embodiment, when the summary result evaluation unit 007 evaluates a function parameter of a collective approximation function that was inputted from the accumulated data summary unit 005 and the function parameter of a sequence approximation function that was read from the summary result memory unit 008, and the evaluation value of the collective approximation function is higher, the summary result evaluation unit 007 deletes the function parameter of the sequence approximation function that is stored in the summary result memory unit 008 that corresponds to the function parameter of the sequence approximation function that was read from the summary result memory unit 008, and newly stores the function parameter of the collective approximation function that was inputted from the accumulated data summary unit 005. However, in the case where the domain of the sequence approximation function that was read from the summary result memory unit 008 is greater than the domain of the collective approximation function, when processing is executed to replace the function parameter of the sequence approximation function with the function parameter of the collective approximation function, missing data occurs. Therefore, the portion with missing data due to replacement is compensated for by using the function parameter of the original sequence approximation function that is stored in the summary result memory unit 008.

As described above, the deletion data instruction unit 401 instructs the sequential data memory management unit 006 on which of the data stored in the sequential data memory unit 002 to delete, and by the sequential data memory management unit 006 operating to delete data, for which there was a deletion instruction, from the sequential data memory unit 002, it is possible to leave data near the point where the sequence summary unit 003 switched functions without having to delete all of the data that is the object of processing by the accumulated data summary unit 005. As a result, the accumulated data summary unit 005 is able to execute summary processing of data near the point where the sequence summary unit 003 switched functions. In doing so, it is possible to prevent the summary results of the accumulated data summary unit 005 from depending on the summary results of the sequence summary unit 003, and it is possible to increase the summary precision or summary rate.

In this case, of the sequential data for which accumulated data summary processing was performed, accumulated data summary processing is performed twice for sequential data that remains (is not deleted) in the sequential data memory unit 002. The accumulated data summary unit 005 performs accumulated data summary processing of data including the sequential data that remained from the previous time; however, the domain of the created collective approximation function can exclude the sequential data for which processing is performed twice, and be a range of sequential data that were not processed the previous time. In doing so, there is no overlapping of collective approximation functions. Furthermore, by taking the domain of the collective approximation function to be from the dividing point of the sequence domain of the previous time to the dividing point of the most recent sequence domain, the domains coincide when the sequence approximation function is replaced with the collective approximation function, so that the range of the domain does not need to be corrected.

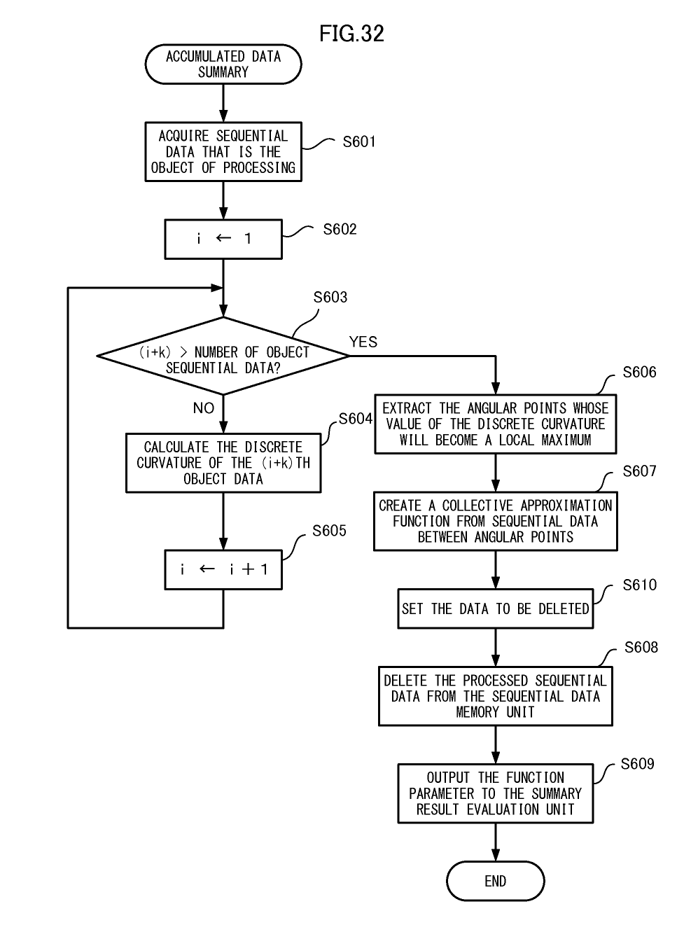

FIG. 32 is a flowchart that illustrates an example of the operation of accumulated data summary of this fifth embodiment. FIG. 32 illustrates the contents of processing that corresponds to step S600 in FIG. 18, FIG. 23, FIG. 28 or FIG. 30. The operation differs from the operation of the accumulated data summary of the first embodiment illustrated in FIG. 20 in that a step (step S610) of setting data to be deleted is newly added. Step S601 to step S607 are the same as in the first embodiment.

After the accumulated data summary unit 005 has summarized sequential data between angular points using a function, and has created a collective approximation function (step S607), the deletion data instruction unit 401 instructs the sequential data memory management unit 006 to delete data at a set amount of time (specified interval) before the time when sequential data was inputted from the accumulated data summary unit 005 (step S610). In other words, the deletion data instruction unit 401 gives an instruction to leave (not to delete) sequential data up to a certain amount of time (specified interval) from the most recent sequential data that is the object of processing by the accumulated data summary unit 005, and to delete the sequential data before that. The sequential data memory management unit 006 deletes data stored in the sequential data memory 002 based on the instruction inputted from the deletion data instruction unit 401 (step S608).

As described above, with the data summary system 100 of this fifth embodiment, in addition to the effect of the first embodiment, it is possible to leave data near the point where the sequence summary unit 003 switched functions without deleting all of the data that is the object of processing by the accumulated data summary unit 005. As a result, the accumulated data summary unit 005 can execute summary processing of data including sequential data before the point where the sequence summary unit 003 switched functions (divided the sequence domain). In doing so, it is possible to prevent the summary result of the accumulated data summary unit 005 from depending on the summary results of the sequence summary unit 003, and it is possible to improve the summary precision or summary rate.

In the construction of this fifth embodiment, with the starting point of the range that is the object of accumulated data summary processing being before the dividing point of the sequence domain, the range for the portion that is the starting point of the domain of the collective approximation function is increased and accumulated data summary processing is performed. In addition to that, or instead of that, accumulated data summary processing can also be performed that includes the sequential data of an enlarged range from the ending point of the domain of the collective approximation function. For example, the accumulated data summary unit 005 performs accumulated data summary processing for the range for which the domain (sequence domain) of the sequence approximation function that is created by the sequence summary unit 003, or in other words, for the sequential data up to the dividing point of the most recent sequence domain, and the ending point of the domain of the collective approximation function that is created is up to a point of sequential data that is older than the dividing point of the most recent sequence domain. Furthermore, by matching the ending point of the domain of the collective approximation function with the dividing point (not the most recent) of the domain of the sequence approximation function, the domains will match when the sequence approximation function is replaced by the collective approximation function.

In the embodiments described above, in order to make the explanation easier to understand, construction was explained in which the sequential data processed by the accumulated data summary unit 005, or the sequential data in the processed range and before that is deleted from the sequential data memory unit 002. By giving an instruction specifying the range of sequential data that is the object of accumulated data summary processing, deletion of sequential data (release of memory space of the sequential data memory unit 002) and accumulated data summary processing can be performed independently without being synchronized.

For example, the sequential data memory unit 002 comprises a ring buffer having capacity that is sufficiently larger than the maximum value of the number of sequential data that can become the object of accumulated data summarization, and by setting the position of the starting point (oldest sequential data for which a collective approximation function has not been created) and ending point (for example, the dividing point of the most recent sequence domain) of the range that is the object of accumulated data summarization, it is possible to perform the processing of the embodiments. In this case, storing data to and deleting data from the ring buffer (releasing of the memory space) can be performed asynchronously and independently from the accumulated data summary process. Construction can be such that the position of the starting point and ending point of the range that is the object of the accumulated data summary is set by the sequential data memory management unit 006.

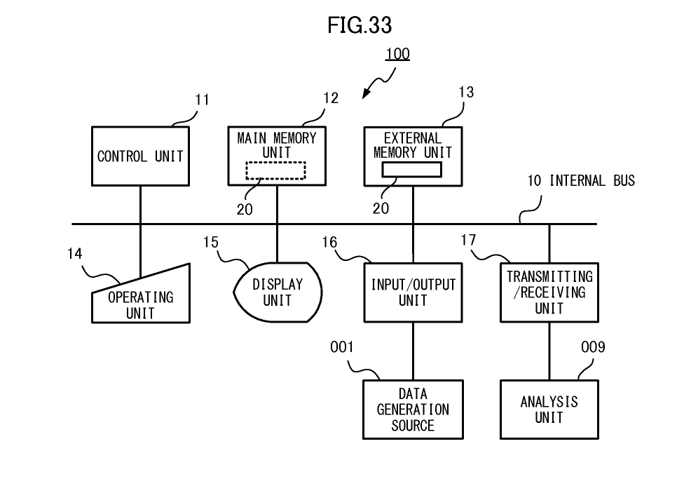

FIG. 33 is a block diagram that illustrates an example of the hardware construction of the data summary system 100 illustrated in FIG. 1, FIG. 21, FIG. 25, FIG. 29 or FIG. 31.

As illustrated in FIG. 33, the data summary system 100 comprises a control unit 11, a main memory unit 12, an external memory unit 13, an operating unit 14, a display unit 15, an input/output unit 16 and a transmitting/receiving unit 17. The main memory unit 12, the external memory unit 13, the operating unit 14, the display unit 15, the input/output unit 16 and the transmitting/receiving unit 17 are all connected to the control unit 11 via an internal bus 10.

The control unit 11 comprises a CPU (Central Processing Unit) executes the processing by the data summary system 100 according to a control program 20 that is stored in the external memory unit 13.

The main memory unit 12 comprises a RAM (Random-Access Memory) in which the control program 20 that is stored in the external memory unit 13 is loaded, and is used as a work area for the control unit 11.

The external memory unit 13 comprises a non-volatile memory such as flash memory, hard disk, DVD-RAM (Digital Versatile Disc Random-Access Memory), DVD-RW (Digital Versatile Disc ReWritable) and the like, and stores in advance a control program 20 for causing the control unit 11 to perform the processing described above, as well as supplies data that the program 20 stores to the control unit 11 according to an instruction from the control unit 11, and stores data supplied from the control unit 11. The sequential data memory unit 002 and summary result memory unit 008 in FIG. 1, FIG. 21, FIG. 25, FIG. 29 or FIG. 31 form the external memory unit 13.

The operating unit 14 comprises a keyboard and a pointing device such as a mouse, and an interface device that connects the keyboard and pointing device to the internal bus 10. Input of the equation for evaluating the summary results, the function correction threshold value T1, function change threshold value T2, or number of intervals k for calculating the discrete curvature is received via the operating unit 14. Moreover, instruction for the display range of the summary results is inputted and supplied to the control unit 11 via the operating unit 14.

The display unit 15 comprises a CRT (Cathode Ray Tube), LCD (Liquid Crystal Display) or the like and displays the function correction threshold value T1, function change threshold value T2 or parameters k for calculating the discrete curvature, or displays the summary results and the like.

The input/output unit 16 comprises a serial interface or parallel interface that connects to the data generation source 001. The data generation source 001 is provided with, for example, a temperature sensor, humidity sensor, an ammeter, an electric power meter, a pressure sensor, an acceleration sensor, an acoustic sensor (microphone), or the like, and sequentially generates data.

The transmitting/receiving unit 17 comprises a communication device, and serial interface or LAN (Local Area Network) interface that is connected to the communication device. The transmitting/receiving unit 17 receives summary result requests from the analysis unit 009, and transmits summary results to the analysis unit 009.

The processing by the sequential data memory unit 002, sequence summary unit 003, accumulated summary control unit 004, accumulated data summary unit 005, sequential data memory management unit 006, summary result evaluation unit 007, summary result memory unit 008, judgment criteria value adjustment unit 101, confirmation required spot check unit 201, resource monitoring unit 301 and deletion data instruction unit 401 is executed by the control program 20 performing processing using the control unit 11, the main memory unit 12, the external memory unit 13, the operating unit 14, the display unit 15, the input/output unit 16 and the transmitting/receiving unit 17 as resources. The data summary system 100 can also comprise a computer that includes an analysis unit 009.

The following construction is also included as preferred forms of the present invention.

In the data summary system according to a first aspect of the present invention, preferably, when the precision of the collective approximation function is higher than the precision of the sequence approximation function, or when the summary rate of the collective approximation function is higher than the summary rate of the sequence approximation function, the summary result evaluation unit replaces the sequence approximation function with the collective approximation function that has a collective domain that includes the range of the sequence domain of the sequence approximation function.

Preferably, the accumulated data summary unit creates a collective approximation function when the input unit accumulates a specified amount or greater of sequential data that is not the object for creating the collective approximation function in the memory device.

Preferably, the data summary system comprises a resource monitoring unit that detects the state of resources, including the rate of usage of the CPU or rate of usage of the memory of the computer that is operated by the data summary system, wherein

the accumulated data summary unit creates a collective approximation function when the state of the resources is within a specified range.

Preferably, the sequence summary unit calculates an approximation difference, which is the difference between a value that was extrapolated in the order of sequential data for which a sequence approximation function, which was created when the previous one sequential data was inputted, was newly inputted, and the value of that newly inputted sequential data; wherein

when the approximation difference exceeds the range of a specified function change threshold value, the sequence summary unit creates a sequence approximation function that comprises a sequence domain, which is a domain that starts from a point between the previous one inputted sequential data and the newly inputted sequential data, and that includes up to that newly inputted sequential data, and a specified function parameter that approximates the values of the previous one inputted sequential data and the newly inputted sequential data;

when the approximation difference exceeds the range of a specified function correction threshold value, and is within the range of the function change threshold value, the sequence summary unit extends the sequence domain of the sequence approximation function that was created when the previous one sequential data was inputted to the newly inputted sequential data, and creates a sequence approximation function that updates the specified function parameter that was created when the previous one sequential data was inputted so that the sequence approximation function approximates the values of the sequential data that are included in the extended sequence domain; and

when the approximation difference is within the range of the function correction threshold value, the sequence summary unit extends the sequence domain of the sequence approximation function that was created when the previous one sequential data was inputted to the newly inputted sequential data, and creates a sequence approximation function that maintains the specified function parameter that was created when the previous one sequential data was inputted.

Furthermore, the data summary system can comprise a judgment criteria value adjustment unit that adjusts the function correction threshold value and/or function change threshold value so that the method of dividing the collective domain of the collective approximation function that the accumulated data summary unit created coincides with the method of dividing the sequence domains in the range of the collective domain; and

the sequence summary unit can use the function correction threshold value and/or the function change threshold value that were adjusted by the judgment criteria value adjustment unit to create the sequence approximation function.

Furthermore, construction can be such that when the precision of the collective approximation function is higher than the precision of the sequence approximation function, or when the summary rate of the collective approximation function is higher than the summary rate of the sequence approximation function, the judgment criteria value adjustment unit adjusts the function correction threshold value and/or the function change threshold value.

Preferably, the data summary system comprises a check unit that, when the sequence summary unit creates the sequence approximation function, and the approximation difference, which is the difference between a value that was extrapolated in the order of sequential data for which a sequence approximation function, which was created when the previous one sequential data was inputted, was newly inputted, and the value of that newly inputted sequential data, is within a specified range, stores the newly inputted sequential data as a confirmation required spot; and

the accumulated data summary unit creates the collective approximation function from sequential data that is accumulated in the memory device and that is within a specified range that includes the confirmation required spot that was stored by the check unit.

Moreover, the check unit can be such that, when the sequence summary unit created the sequence approximation function that comprises the sequence domain that includes from a point between the previous one inputted sequential data and the newly inputted sequential data up to the newly inputted sequential data, and the specified function parameter that approximates the values of the previous one inputted sequential data and the newly inputted sequential data, it stores the newly inputted sequential data as the confirmation required spot.

Preferably, the accumulated data summary unit creates the collective approximation function from the sequential data from one dividing point in the sequence domain to another dividing point.

Preferably, the accumulated data summary unit excludes the sequential data up to one set interval from the most recent dividing point of the sequence domain, and creates the collective approximation function from the sequential data of a specified range before that.

Preferably, the accumulated data summary unit creates the specified function parameter that approximates the values of sequential data, including the sequential data in a specified range before and/or after the sequential data in the specified range that is the object for which the collected approximation is created.

Preferably, the accumulated data summary unit extracts the sequential data, which are angular points and whose absolute value of the discrete curvature is larger than a specified value and that are calculated from the previous one sequential data and a specified number of sequential data before and after that previous one sequential data, as dividing points of the collective domain, and creates a specified function parameter that approximates the values of the sequential data for each of the sequential data between the dividing points.

In the data summary method according to a second aspect of the present invention, preferably the summary result evaluation step replaces the sequence approximation function with the collective approximation function that has the collective domain that includes the range of the sequence domain of the sequence approximation function in the case when the precision of the collective approximation function is higher than the precision of the sequence approximation function, or when the summary rate of the collective approximation function is higher than the summary rate of the sequence approximation function.

Preferably, the accumulated data summary step creates a collective approximation function when the input step accumulated a specified amount or greater of sequential data that is not the object for creating a collective approximation function in the memory device.

Preferably, the data summary method comprises a resource monitoring step that detects the state of resources, including the rate of usage of the CPU or rate of usage of the memory of the computer that executes the data summary method, wherein

the accumulated data summary step creates the collective approximation function when the state of the resources is within a specified range.

Preferably, the sequence summary step calculates an approximation difference, which is the difference between a value that was extrapolated in the order of sequential data for which a sequence approximation function, which was created when the previous one sequential data was inputted, was newly inputted, and the value of that newly inputted sequential data; wherein

when the approximated difference exceeds the range of a specified function change threshold value, the sequence summary step creates a sequence approximation function that comprises the sequence domain, which is a domain that starts from a point between the previous one inputted sequential data and the newly inputted sequential data, and that includes up to that newly inputted sequential data, and the specified function parameter that approximates the values of the previous one inputted sequential data and the newly inputted sequential data;

when the approximation difference exceeds the range of a specified function correction threshold value, and is within the range of the function change threshold value, the sequence summary step extends the sequence domain of the sequence approximation function that was created when the previous one sequential data was inputted to the newly inputted sequential data, and creates a sequence approximation function that updates the specified function parameter that was created when the previous one sequential data was inputted so that the sequence approximation function approximates the values of the sequential data that are included in the extended sequence domain; and

when the approximation difference is within the range of the function correction threshold value, the sequence summary step extends the sequence domain of the sequence approximation function that was created when the previous one sequential data was inputted to the newly inputted sequential data, and creates the sequence approximation function that maintains the specified function parameter that was created when the previous one sequential data was inputted.

Furthermore, the data summary method can comprise a judgment criteria value adjustment step that adjusts the function correction threshold value and/or function change threshold value so that the method of dividing the collective domain of the collective approximation function that the accumulated data summary step created coincides with the method of dividing the sequence domains in the range of the collective domain; and

the sequence summary step can use the function correction threshold value and/or the function change threshold value that were adjusted by the judgment criteria value adjustment step to create a sequence approximation function.

Furthermore, construction can be such that when the precision of the collective approximation function is higher than the precision of the sequence approximation function, or when the summary rate of the collective approximation function is higher than the summary rate of the sequence approximation function, the judgment criteria value adjustment step adjusts the function correction threshold value and/or the function change threshold value.

Preferably, the data summary method comprises a check step that, when the sequence summary step creates a sequence approximation function, and the approximation difference, which is the difference between a value that was extrapolated in the order of sequential data for which a sequence approximation function, which was created when the previous one sequential data was inputted, was newly inputted, and the value of that newly inputted sequential data, is within a specified range, stores the newly inputted sequential data as a confirmation required spot; and

the accumulated data summary step creates the collective approximation function from the sequential data that is accumulated in the memory device and that is within a specified range that includes the confirmation required spot that was stored by the check step.

Preferably, the check step can be such that, when the sequence summary unit created a sequence approximation function that comprises the sequence domain that includes from a point between the previous one inputted sequential data and the newly inputted sequential data up to the newly inputted sequential data, and the specified function parameter that approximates the values of the previous one inputted sequential data and the newly inputted sequential data, it stores the newly inputted sequential data as the confirmation required spot.

Preferably, the accumulated data summary step creates the collective approximation function from the sequential data from one dividing point in the sequence domain to another dividing point.

Preferably, the accumulated data summary step excludes the sequential data up to one set interval from the most recent dividing point of the sequence domain, and creates the collective approximation function from the sequential data of a specified range before that.

Preferably, the accumulated data summary step creates a specified function parameter that approximates the values of sequential data, including the sequential data in a specified range before and/or after the sequential data in the specified range that is the object for which the collected approximation is created.

Preferably, the accumulated data summary step extracts sequential data, which are angular points and whose absolute values of the discrete curvature are larger than a specified value and that are calculated from the previous one sequential data and a specified number of sequential data before and after that previous one sequential data, as dividing points of the collective domain, and creates the specified function parameter that approximates the values of the sequential data for each of the sequential data between the dividing points.

In addition, the hardware construction and flowcharts are only examples, and can be arbitrarily changed or modified.

The portion that is the center for performing the processing for the data summary system 100 that comprises a control unit 11, a main memory unit 12, an external memory unit 13, a transmitting/receiving unit 17 and an internal bus 10 does not rely on a special system and can be achieved using a normal computer system. For example, the computer program for executing the operation above can be stored on a recording medium (flexible disk, CD-ROM, DVD-ROM and the like) that is readable by a computer and distributed, and the data summary system 100 that executes the processing above can be configured by installing that computer program on a computer. It is also possible to store that computer on a memory device of a server device on a communication network such as the Internet, and the data summary system 100 can be configured by a normal computer system downloading that program.

When the function of the data summary system is achieved by the OS (Operating System) and application program sharing, or by the OS and application working together, it is possible to store only the application program on a recording medium or in a memory device.

It is also possible to superimpose the computer program on a carrier wave, and to distribute the program via a communication network. For example, it is possible to post the computer program on a bulletin board (BBS, Bulletin Board System) on a communication network, and to distribute the computer program via a network. The processing described above can be executed by activating this computer program, and under the control of the OS, similarly execute the application program.

This application claims priority based on Japanese Patent Application No. 2009-187587, the specification, claims and drawings of Japanese Patent Application No, 2009-187587 being incorporated in their entirety by reference in this specification.

### INDUSTRIAL APPLICABILITY

The present invention can be suitably applied to a system in which it is necessary to sequentially summarize data that is sequentially generated such as log data that is outputted from a server or data that is outputted from a sensor, and delete the amount of information.

### EXPLANATION OF SYMBOLS

10 Internal bus
11 Control unit
12 Main memory unit
13 External memory unit
14 Operating unit
15 Display unit
16 Input/output unit
17 Transmitting/receiving unit
20 Control program
001 Data generation source
002 Sequential data memory unit
003 Sequence summary unit
004 Accumulated summary control unit
005 Accumulated data summary unit
006 Sequential data memory management unit
007 Summary result evaluation unit
008 Summary result memory unit
009 Analysis unit
100 Data summary system
101 Judgment criteria value adjustment unit
201 Confirmation required spot check unit
301 Resource monitoring unit
401 Deletion data instruction unit

1. A data summary system comprising:
an input unit that inputs sequential data, which is data that is sequentially generated and comprises information that includes the order of generation and the value at that time, and accumulates that sequential data in a memory device every time the sequential data is generated;
a sequence summary unit that, every time the sequential data is inputted, creates one of:
a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;
a sequence approximation function in which the sequence domain of the sequence approximation function that was created when the previous one sequential data was inputted is extended up to the newly inputted sequential data, and the specified function parameter that was created when the previous one sequential data was inputted is changed so as to approximate the values of the sequential data included in the extended sequence domain; or
a sequence approximation function in which the sequence domain of the sequence approximation function that was created when the previous one sequential data was inputted is extended up to the newly inputted sequential data, and the specified function parameter that was created when the previous one sequential data was inputted is maintained;
a summary memory unit that stores the sequence approximation function that was created by the sequence summary unit;
an accumulated data summary unit that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and
a summary result evaluation unit that replaces the sequence approximation function that is stored in the summary memory unit with the collective approximation function that has the collective domain that includes the range of sequence domain of the sequence approximation function.

2. The data summary system according to claim 1, wherein, when the summary precision of the collective approximation function is higher than the precision of the sequence approximation function, or when the summary rate of the collective approximation function is higher than the summary rate of the sequence approximation function, the summary result evaluation unit replaces the sequence approximation function with the collective approximation function that has the collective domain that includes the range of the sequence domain of the sequence approximation function.

3. The data summary system according to claim 1, wherein, when the amount of sequential data that is not the object of creating the collective approximation function that is stored in the memory device by the input unit is greater than a specified amount, the accumulated data summary unit creates the collective approximation function.

4. The data summary system according to claim 1, further comprising
a resource monitoring unit that detects the status of recourses that include the CPU usage rate or memory usage rate of the computer that is operated by the data summary system, wherein
the accumulated data summary unit creates the collective approximation function when the status of the resources is within a specified range.

5. The data summary system according to claim 1, wherein
the sequence summary unit calculates an approximation difference, which is the difference between a value that was extrapolated in the order of sequential data for which a sequence approximation function, which was created when the previous one sequential data was inputted, was newly inputted, and the value of that newly inputted sequential data; and
when the approximation difference exceeds the range of a specified function change threshold value, the sequence summary unit creates a sequence approximation function that comprises a sequence domain, which is a domain that starts from a point between the previous one inputted sequential data and the newly inputted sequential data, and that includes up to that newly inputted sequential data, and the specified function parameter that approximates the values of the previous one inputted sequential data and the newly inputted sequential data;
when the approximation difference exceeds the range of a specified function correction threshold value, and is within the range of the function change threshold value, the sequence summary unit extends the sequence domain of the sequence approximation function that was created when the previous one sequential data was inputted to the newly inputted sequential data, and creates a sequence approximation function that updates the specified function parameter that was created when the previous one sequential data was inputted so that the sequence approximation function approximates the values of the sequential data that are included in the extended sequence domain; and
when the approximation difference is within the range of the function correction threshold value, the sequence summary unit extends the sequence domain of the sequence approximation function that was created when the previous one sequential data was inputted to the newly inputted sequential data, and creates a sequence approximation function that maintains the specified function parameter that was created when the previous one sequential data was inputted.

6. The data summary system according to claim 5, further comprising
a judgment criteria value adjustment unit that adjusts the function correction threshold value and/or function change threshold value so that the method of dividing the collective domain of the collective approximation function that the accumulated data summary unit created coincides with the method of dividing the sequence domains in the range of the collective domain; wherein
the sequence summary unit uses the function correction threshold value and/or the function change threshold value that were adjusted by the judgment criteria value adjustment unit to create the sequence approximation function.

7. The data summary system according to claim 6, wherein the judgment criteria value adjustment unit adjusts the function correction threshold value and/or the function change threshold value when the precision of the collective approximation function is higher than the precision of the sequence approximation function, or when the summary rate of the collective approximation function is higher than the summary rate of the sequence approximation function.

8. The data summary system according to claim 1, further comprising
a check unit that, when the sequence summary unit creates a sequence approximation function, and the approximation difference, which is the difference between a value that was extrapolated in the order of sequential data for which a sequence approximation function, which was created when the previous one sequential data was inputted, was newly inputted, and the value of that newly inputted sequential data, is within a specified range, stores the newly inputted sequential data as a confirmation required spot; wherein
the accumulated data summary unit creates the collective approximation function from sequential data that is accumulated in the memory device and that is within a specified range that includes the confirmation required spot that was stored by the check unit.

9. The data summary system according to claim 8, wherein, when the sequence summary unit created the sequence approximation function that comprises the sequence domain that includes from a point between the previous one inputted sequential data and the newly inputted sequential data up to the newly inputted sequential data, and the specified function parameter that approximates the values of the previous one inputted sequential data and the newly inputted sequential data, the check unit stores the newly inputted sequential data as a confirmation required spot.

10. The data summary system according to claim 1, wherein the accumulated data summary unit creates the collective approximation function from the sequential data from one dividing point in the sequence domain to another dividing point.

11. The data summary system according to claim 1, wherein the accumulated data summary unit excludes the sequential data up to one set interval from the most recent dividing point of the sequence domain, and creates the collective approximation function from the sequential data of a specified range before that.

12. The data summary system according to claim 1, wherein the accumulated data summary unit creates the specified function parameter that approximates the values of sequential data, including the sequential data in a specified range before and/or after the sequential data in the specified range that is the object for which the collected approximation is created.

13. The data summary system according to claim 1, wherein the accumulated data summary unit extracts sequential data, which are angular points and whose absolute values of the discrete curvature are larger than a specified value and that are calculated from the previous one sequential data and a specified number of sequential data before and after that previous one sequential data, as dividing points of the collective domain, and creates a specified function parameter that approximates the values of the sequential data for each of the sequential data between the dividing points.

14. A data summary method comprising:
an input step that inputs sequential data, which is data that is sequentially generated and comprises information that includes the order of generation and the value at that time, and accumulates that sequential data in a memory device every time the sequential data is generated;
a sequence summary step that, every time the sequential data is inputted, creates one of:
a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;
a sequence approximation function in which the sequence domain of the sequence approximation function that was created when the previous one sequential data was inputted is extended up to the newly inputted sequential data, and the specified function parameter that was created when the previous one sequential data was inputted is changed so as to approximate the values of the sequential data included in the extended sequence domain; or
a sequence approximation function in which the sequence domain of the sequence approximation function that was created when the previous one sequential data was inputted is extended up to the newly inputted sequential data, and the specified function parameter that was created when the previous one sequential data was inputted is maintained;
a summary memory step that stores the sequence approximation function that was created by the sequence summary step;
an accumulated data summary step that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and
a summary result evaluation step that replaces the sequence approximation function that is stored in the summary memory step with the collective approximation function that has the collective domain that includes the range of sequence domain of the sequence approximation function.

15. The data summary method according to claim 14, wherein, when the summary precision of the collective approximation function is higher than the precision of the sequence approximation function, or when the summary rate of the collective approximation function is higher than the summary rate of the sequence approximation function, the summary result evaluation step replaces the sequence approximation function with the collective approximation function that has the collective domain that includes the range of the sequence domain of the sequence approximation function.

16. The data summary method according to claim 14, wherein, when the amount of sequential data that is not the object of creating a collective approximation function that is stored in the memory device by the input step is greater than a specified amount, the accumulated data summary step creates the collective approximation function.

17. The data summary method according to claim 14, further comprising
a resource monitoring step that detects the status of recourses that include the CPU usage rate or memory usage rate of the computer that executes the data summary method, wherein
the accumulated data summary step creates the collective approximation function when the status of the resources is within a specified range.

18. The data summary method according to claim 14, wherein
the sequence summary step calculates an approximation difference, which is the difference between a value that was extrapolated in the order of sequential data for which the sequence approximation function, which was created when the previous one sequential data was inputted, was newly inputted, and the value of that newly inputted sequential data; and
when the approximation difference exceeds the range of a specified function change threshold value, the sequence summary step creates the sequence approximation function that comprises the sequence domain, which is a domain that starts from a point between the previous one inputted sequential data and the newly inputted sequential data, and that includes up to that newly inputted sequential data, and the specified function parameter that approximates the values of the previous one inputted sequential data and the newly inputted sequential data;
when the approximation difference exceeds the range of a specified function correction threshold value, and is within the range of the function change threshold value, the sequence summary step extends the sequence domain of the sequence approximation function that was created when the previous one sequential data was inputted to the newly inputted sequential data, and creates the sequence approximation function that updates the specified function parameter that was created when the previous one sequential data was inputted so that the sequence approximation function approximates the values of the sequential data that are included in the extended sequence domain; and
when the approximation difference is within the range of the function correction threshold value, the sequence summary step extends the sequence domain of the sequence approximation function that was created when the previous one sequential data was inputted to the newly inputted sequential data, and creates the sequence approximation function that maintains the specified function parameter that was created when the previous one sequential data was inputted.

19. The data summary method according to claim 18, further comprising
a judgment criteria value adjustment step that adjusts the function correction threshold value and/or function change threshold value so that the method of dividing the collective domain of the collective approximation function that the accumulated data summary step created coincides with the method of dividing the sequence domains in the range of the collective domain; wherein
the sequence summary step uses the function correction threshold value and/or the function change threshold value that were adjusted by the judgment criteria value adjustment step to create the sequence approximation function.

20. The data summary method according to claim 19, wherein the judgment criteria value adjustment step adjusts the function correction threshold value and/or the function change threshold value when the precision of the collective approximation function is higher than the precision of the sequence approximation function, or when the summary rate of the collective approximation function is higher than the summary rate of the sequence approximation function.

21. The data summary method according to claim 14, further comprising
a check step that, when the sequence summary step creates the sequence approximation function, and the approximation difference, which is the difference between a value that was extrapolated in the order of sequential data for which the sequence approximation function, which was created when the previous one sequential data was inputted, was newly inputted, and the value of that newly inputted sequential data, is within a specified range, stores the newly inputted sequential data as a confirmation required spot; wherein
the accumulated data summary step creates the collective approximation function from sequential data this is accumulated in the memory device and that is within a specified range that includes the confirmation required spot that was stored by the check step.

22. The data summary method according to claim 21, wherein, when the sequence summary step created the sequence approximation function that comprises the sequence domain that includes from a point between the previous one inputted sequential data and the newly inputted sequential data up to the newly inputted sequential data, and the specified function parameter that approximates the values of the previous one inputted sequential data and the newly inputted sequential data, the check step stores the newly inputted sequential data as a confirmation required spot.

23. The data summary method according to claim 14, wherein the accumulated data summary step creates the collective approximation function from the sequential data from one dividing point in the sequence domain to another dividing point.

24. The data summary method according to claim 14, wherein the accumulated data summary step excludes the sequential data up to one set interval from the most recent dividing point of the sequence domain, and creates the collective approximation function from the sequential data of a specified range before that.

25. The data summary method according to claim 14, wherein the accumulated data summary step creates the specified function parameter that approximates the values of sequential data, including the sequential data in a specified range before and/or after the sequential data in the specified range that is the object for which the collected approximation is created.

26. The data summary method according to claim 14, wherein the accumulated data summary step extracts the sequential data, which are angular points and whose absolute values of the discrete curvature are larger than a specified value and that are calculated from the previous one sequential data and a specified number of sequential data before and after that previous one sequential data, as dividing points of the collective domain, and creates the specified function parameter that approximates the values of the sequential data for each of the sequential data between the dividing points.

27. A recording medium that is readable by a computer, a program being recorded thereon that causes a computer to execute:
an input step that inputs sequential data, which is data that is sequentially generated and comprises information that includes the order of generation and the value at that time, and accumulates that sequential data in a memory device every time the sequential data is generated;
a sequence summary step that, every time the sequential data is inputted, creates one of:
a sequence approximation function that comprises a sequence domain, which is a domain that starts from a point between the previous one inputted sequential data and newly inputted sequential data and includes up to that newly inputted sequential data, and a specified function parameter that approximates the values of the previous one inputted sequential data and the newly inputted sequential data;
a sequence approximation function in which the sequence domain of the sequence approximation function that was created when the previous one sequential data was inputted is extended up to the newly inputted sequential data, and the specified function parameter that was created when the previous one inputted sequential data is changed so as to approximate the values of the sequential data included in the extended sequence domain; or
a sequence approximation function in which the sequence domain of the sequence approximation function that was created when the previous one sequential data was inputted is extended up to the newly inputted sequential data, and the specified function parameter that was created when the previous one sequential data was inputted is maintained;
a summary memory step that stores the sequence approximation function that was created by the sequence summary step;
an accumulated data summary step that, when certain conditions are met, creates a collective approximation function that comprises: a collective domain, which is a domain of a specified range of the sequential data that are accumulated in the memory device in a continuous order, where the range of information that includes the order of that specified range of sequential data is divided into one or two or more, and a specified function parameter that approximates the values of the sequential data in that divided collective domain; and
a summary result evaluation step that replaces the sequence approximation function that is stored in the summary memory step with the collective approximation function that has the collective domain that includes the range of sequence domain of the sequence approximation function.
